(19) United States
(12) Patent Application Publication
(10) Pub. No.: US 2009/0324459 A1
(43) Pub. Date: Dec. 31, 2009

(54) Three-Train Catalytic Gasification Systems

(75) Inventors: Earl T. Robinson, Lakeland, FL (US); Francis S. Lau, Darien, IL (US); Dwain Dodson, Valparaiso, IN (US)

Correspondence Address: MCDONNELL BOEHNEN HULBERT & BERGHOFF LLP, 300 S. WACKER DRIVE, SUITE 3100, CHICAGO, IL, 60606, US

(73) Assignee: GREATPOINT ENERGY, INC., Chicago, IL (US)

(21) Appl. No.: 12/492,477

(22) Filed: Jun. 26, 2009

Related U.S. Application Data
(60) Provisional application No. 61/076,440, filed on Jun. 27, 2008.

(51) Int. Cl. B01J 8/00

(52) U.S. Cl. 422/187

(57) ABSTRACT

Systems to convert a carbonaceous feedstock into a plurality of gaseous products are described. The systems include, among other units, three separate gasification reactors for the gasification of a carbonaceous feedstock in the presence of an alkali metal catalyst into the plurality of gaseous products including at least methane. Each of the gasification reactors may be supplied with the feedstock from a single or separate catalyst loading and/or feedstock preparation unit operations. Similarly, the hot gas streams from each gasification reactor may be purified via their combination at a heat exchanger, acid gas removal or methane removal unit operations. Product purification may comprise trace contaminant removal units, ammonia removal and recovery units, and sour shift units.

### CROSS REFERENCE TO RELATED APPLICATIONS

This application claims priority under 35 U.S.C. § 119 from U.S. Provisional Application Ser. No. 61/076,440 (filed Jun. 27, 2008), the disclosure of which is incorporated by reference herein for all purposes as if fully set forth.

This application is related to commonly owned and concurrently filed U.S. patent application Ser. No. ______, attorney docket no. FN-0034 US NP1, entitled TWO-TRAIN CATALYTIC GASIFICATION SYSTEMS; Ser. No. ______, attorney docket no. FN-0036 US NP1, entitled FOUR-TRAIN CATALYTIC GASIFICATION SYSTEMS; Ser. No. ______, attorney docket no. FN-0037 US NP1, entitled FOUR-TRAIN CATALYTIC GASIFICATION SYSTEMS; and Ser. No. ______, attorney docket no. FN-0038 US NP1, entitled FOUR-TRAIN CATALYTIC GASIFICATION SYSTEMS, the disclosures of which are incorporated by reference herein for all purposes as if fully set forth.

### FIELD OF THE INVENTION

The present invention relates to systems configuration having three catalytic gasification reactors (i.e., three trains) for preparation of gaseous products, and in particular, methane via the catalytic gasification of carbonaceous feedstocks in the presence of steam.

### BACKGROUND OF THE INVENTION

In view of numerous factors such as higher energy prices and environmental concerns, the production of value-added gaseous products from lower-fuel-value carbonaceous feedstocks, such as biomass, coal and petroleum coke, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1 and GB 1599932.

In general, carbonaceous materials, such as coal or petroleum coke, can be converted to a plurality of gases, including value-added gases such as methane, by the gasification of the material in the presence of an alkali metal catalyst source and steam at elevated temperatures and pressures. Fine unreacted carbonaceous materials are removed from the raw gases produced by the gasifier, the gases are cooled and scrubbed in multiple processes to remove undesirable contaminants and other side-products including carbon monoxide, hydrogen, carbon dioxide, and hydrogen sulfide.

In order to increase the throughput of carbonaceous materials to gaseous products, including methane, multiple parallel gasification trains can be run simultaneously, each having dedicated feedstock processing and gas purification and separation systems. In doing so, the loss of a single component, due to failure or maintenance, in any train can require shutting down of the entire gasification train, resulting in loss of production capacity. Each unit in the feedstock processing and gas purification and separation systems can have differing capacities, resulting in over- or under-burdening with particular units within the overall system, losses in efficiency, and increased production costs. Therefore, a need remains for improved gasification systems with increased efficiency and component utilization, and that minimize losses in overall production capacities.

### SUMMARY OF THE INVENTION

In one aspect, the invention provides a gasification system to generate a plurality of gaseous products from a catalyzed carbonaceous feedstock, the system comprising:

(a) a first, a second and a third gasifying reactor unit, wherein each gasifying reactor unit independently comprises:
(A1) a reaction chamber in which a catalyzed carbonaceous feedstock and steam are converted to (i) a plurality of gaseous products comprising methane, hydrogen, carbon monoxide, carbon dioxide, hydrogen sulfide and unreacted steam, (ii) unreacted carbonaceous fines; and (iii) a solid char product comprising entrained catalyst;
(A2) a feed inlet to supply the catalyzed carbonaceous feedstock into the reaction chamber;
(A3) a steam inlet to supply steam into the reaction chamber;
(A4) a hot gas outlet to exhaust a hot first gas stream out of the reaction chamber, the hot first gas stream comprising the plurality of gaseous products;
(A5) a char outlet to withdraw the solid char product from the reaction chamber; and
(A6) a fines remover unit to remove at least a substantial portion of the unreacted carbonaceous fines that may be entrained in the hot first gas stream;

(b) (1) a single catalyst loading unit to supply the catalyzed carbonaceous feedstock to the feed inlets of the first, second and third gasifying reactor units, or
(2) a first catalyst loading unit and a second catalyst loading unit to supply the catalyzed carbonaceous feedstock to the feed inlets of the first, second and third gasifying reactor units, or
(3) a first, a second and a third catalyst loading unit to supply the catalyzed carbonaceous feedstock to the feed inlets of the first, second and third gasifying reactor units,

wherein each catalyst loading unit independently comprises:
(B1) a loading tank to receive carbonaceous particulates and load catalyst onto the carbonaceous particulates to form the catalyzed carbonaceous feedstock; and
(B2) a dryer to thermally treat the catalyzed carbonaceous feedstock to reduce moisture content;

(c) (1) when only the single catalyst loading unit is present, a single carbonaceous material processing unit to supply the carbonaceous particulates to the loading tank of the single catalyst loading unit, or
(2) when only the first and second catalyst loading units are present, (i) a single carbonaceous material processing unit to supply the carbonaceous particulates to the loading tanks of the first and second catalyst loading units, or (ii) a first and a second carbonaceous material processing unit to supply the carbonaceous particulates to the loading tanks of the first and second catalyst loading units, or
(3) when the first, second and third catalyst loading units are present, (i) a single carbonaceous material processing unit to supply the carbonaceous particulates to the loading tanks of the first, second and third catalyst loading units, or (ii) a first and a second carbonaceous material processing unit to supply the carbonaceous particulates to the loading tanks of the first, second and third catalyst loading units, or (iii) a first, a second and a third carbonaceous material processing unit to supply the carbonaceous particulates to the loading tanks of the first, second and third catalyst loading units,

wherein each carbonaceous material processing unit independently comprises:
(C1) a receiver to receive and store a carbonaceous material; and
(C2) a grinder in communication with the receiver to grind the carbonaceous material into the carbonaceous particulates;

(d) (1) a single heat exchanger unit to remove heat energy from the hot first gas streams from the first, second and third gasifying reactor units to generate steam and produce a single cooled first gas stream, or
(2) a first and a second heat exchanger unit to remove heat energy from the hot first gas streams from the first, second and third gasifying reactor units to generate steam and produce a first cooled first gas stream and a second cooled first gas stream, or
(3) a first, a second and a third heat exchanger unit to remove heat energy from the hot first gas stream from the first, second and third gasifying reactor units to generate steam and produce a first cooled first gas stream, a second cooled first gas stream, and a third cooled first gas stream;

(e) (1) when only the single heat exchanger unit is present, a single acid gas remover unit to remove at least a substantial portion of the carbon dioxide and at least a substantial portion of the hydrogen sulfide from the single cooled first gas stream, to produce a single acid gas-depleted gas stream comprising at least a substantial portion of the methane, at least a substantial portion of the hydrogen, and, optionally, at least a portion of the carbon monoxide from the single cooled first gas stream, or
(2) when only the first and second heat exchanger units are present, (i) a single acid gas remover unit to remove at least a substantial portion of the carbon dioxide and at least a substantial portion of the hydrogen sulfide from the first and second cooled first gas streams, to produce a single acid gas-depleted gas stream comprising at least a substantial portion of the methane, at least a substantial portion of the hydrogen, and, optionally, at least a portion of the carbon monoxide from the first and second cooled gas streams, or (ii) a first and a second acid gas remover unit to remove at least a substantial portion of the carbon dioxide and at least a substantial portion of the hydrogen sulfide from the first and second cooled first gas streams, to produce a first acid gas-depleted gas stream and a second acid gas-depleted gas stream comprising at least a substantial portion of the methane, at least a substantial portion of the hydrogen, and, optionally, at least a portion of the carbon monoxide from the first and second cooled gas streams, or
(3) when the first, second and third heat exchanger units are present, (i) a single acid gas remover unit to remove at least a substantial portion of the carbon dioxide and at least a substantial portion of the hydrogen sulfide from the first, second and third cooled gas streams, to produce a single acid gas-depleted gas stream comprising at least a substantial portion of the methane, at least a substantial portion of the hydrogen, and, optionally, at least a portion of the carbon monoxide from the first, second and third cooled gas streams, or (ii) a first and a second acid gas remover unit to remove at least a substantial portion of the carbon dioxide and at least a substantial portion of the hydrogen sulfide from the first, second and third cooled first gas streams, to produce a first acid gas-depleted gas stream and a second acid gas-depleted gas stream, wherein the first and second acid gas-depleted gas streams together comprise at least a substantial portion of the methane, at least a substantial portion of the hydrogen and, optionally, at least a portion of the carbon monoxide from the first, second and third cooled first gas streams, or (iii) a first, a second and a third acid gas remover unit to remove at least a substantial portion of the carbon dioxide and at least a substantial portion of the hydrogen sulfide from the first, second and third cooled first gas streams to produce a first acid gas-depleted gas stream, a second acid gas-depleted gas stream and a third acid gas-depleted gas stream, wherein the first, second and third acid gas-depleted gas streams together comprise at least a substantial portion of the methane, at least a substantial portion of the hydrogen, and, optionally, at least a portion of the carbon monoxide from the first, second and third cooled first gas stream;

(f) (1) when only the single acid gas-depleted gas stream is present, a single methane removal unit to separate and recover methane from the single acid gas-depleted gas stream, to produce a single methane-depleted gas stream and a single methane product stream, the single methane product stream comprising at least a substantial portion of the methane from the single acid gas-depleted stream, or
(2) when only the first and second acid gas-depleted gas streams are present, (i) a single methane removal unit to separate and recover methane from the first and second acid gas-depleted gas streams, to produce a single methane-depleted gas stream and a single methane product stream, the single methane product stream comprising at least a substantial portion of the methane from the first and second acid gas-depleted streams, or (ii) a first and a second methane removal unit to separate and recover methane from the first and second acid gas-depleted gas streams, to produce a first methane-depleted gas stream and a first methane product stream, and a second methane-depleted gas stream and a second methane product stream, the first and second methane product streams together comprising at least a substantial portion of the methane from the first and second acid gas-depleted streams, or
(3) when the first, second and third acid gas-depleted gas streams are present, (i) a single methane removal unit to separate and recover methane from the first, second and third acid gas-depleted gas streams, to produce a single methane-depleted gas stream and a single methane product stream, the single methane product stream comprising at least a substantial portion of the methane from the first, second and third acid gas-depleted streams, or (ii) a first and a second methane removal unit to separate and recover methane from the first, second and third acid gas-depleted gas streams, to produce a first methane-depleted gas stream and a first methane product stream, and a second methane-depleted gas stream and a second methane product stream, the first and second methane product streams together comprising at least a substantial portion of the methane from the first, second and third acid gas-depleted streams, or (iii) a first, a second and a third methane removal unit to separate and recover methane from the first, second and third acid gas-depleted gas streams, to produce a first methane-depleted gas stream and a first methane product stream, a second methane-depleted gas stream and a second methane product stream, and a third methane-depleted gas stream and a third methane product stream, the first, second and third methane product stream together comprising at least a substantial portion of the methane from the first, second and third acid gas-depleted streams; and

(g) (1) a single steam source to supply steam to the first, second and third gasifying reactor units, or
(2) a first and a second steam source to supply steam to the first, second, and third gasifying reactor units; or
(3) a first, a second and a third steam source to supply steam to the first, second and third gasifying reactor units.

In certain embodiments, the gasification systems may further comprise one or more of:

(h) a trace contaminant removal unit between a heat exchanger unit and an acid gas remover unit, to remove at least a substantial portion of one or more trace contaminants from the single cooled first gas stream, or, when present, one or more of the first, second, and third cooled first gas streams, wherein the single cooled first gas stream or the one or more of the first, second, and third cooled first gas streams further comprise one or more trace contaminants comprising one or more of COS, Hg and HCN;

(i) a reformer unit to convert a portion of the single methane product stream, or when present, at least a portion of one or more of the first, second, and third methane product streams into a syngas;

(j) a methane compressor unit to compress at least a portion of the single methane product stream, or when present, one or more of the first, second, and third methane product streams;

(k) a carbon dioxide recovery unit to separate and recover carbon dioxide removed by the single acid gas remover unit, or when present, one or more of the first, second, and third acid gas remover units;

(l) a sulfur recovery unit to extract and recover sulfur from the hydrogen sulfide removed by the single acid gas remover unit, or when present, one or more of the first, second, and third acid gas remover units;

(m) a catalyst recovery unit to extract and recover at least a portion of the entrained catalyst from at least a portion of the solid char product, and recycle at least a portion of the recovered catalyst to the single catalyst loading unit, or when present, one or more of the first, second, third catalyst loading units;

(n) a gas recycle loop to recycle at least a portion of the single methane-depleted gas stream, or when present, at least a portion of one or more of the first methane-depleted gas stream, the second methane-depleted gas stream, and the third methane-depleted gas stream to at least one or more of the first, second, and third gasifying reactor units;

(o) a waste water treatment unit to treat waste water generated by the system;

(p) a superheater to superheat the steam in or from the single steam source, or when present the first steam source and/or second steam source;

(q) a steam turbine to generate electricity from at least a portion of the steam supplied by the single steam source, or when present the first steam source and/or the second steam source; and

(r) a sour shift unit between a heat exchanger and an acid gas remover unit, to contact a cooled first gas stream with an aqueous medium under conditions suitable to convert at least a portion of carbon monoxide in the cooled first gas stream to carbon dioxide.

In the event that the plurality of gaseous products comprises ammonia, the system may further optionally comprise an ammonia remover unit between a heat exchanger unit and an acid gas removal unit, to remove at least a substantial portion of the ammonia from a cooled first gas stream to produce an ammonia-depleted cooled first gas stream, ultimately to feed to the acid gas remover unit.

The systems in accordance with the present invention are useful, for example, for producing methane from various carbonaceous feedstocks. A preferred system is one which produces a product stream of “pipeline-quality natural gas” as described in further detail below.

### BRIEF DESCRIPTION OF THE DRAWINGS

FIG. 1 is a diagram of an embodiment of the gasification system of the invention having a single feedstock processing unit, three catalyst loading units, three heat exchanger units, a single acid gas removal unit and a single methane removal unit.

FIG. 2 is a diagram of an embodiment of the gasification system of the invention having a single feedstock processing unit, a single catalyst loading unit, three heat exchanger units, a single acid gas removal unit and a single methane removal unit.

FIG. 3 is a diagram of an embodiment of the gasification system of the invention having a single feedstock processing unit, three catalyst loading units, three heat exchanger units, two acid gas removal units and a single methane removal unit.

FIG. 4 is a diagram of an embodiment of the gasification system of the invention having a single feedstock processing unit, three single catalyst loading units, three heat exchanger units, two acid gas removal units and two methane removal units.

FIG. 5 is a diagram of an embodiment of the gasification system of the invention having a single feedstock processing unit, a single catalyst loading unit, three heat exchanger units, three acid gas removal units and a single methane removal unit.

FIG. 6 is a diagram of an embodiment of the gasification system of the invention having a single feedstock processing unit, a single catalyst loading unit, three heat exchanger units, three acid gas removal units, two methane removal units and a single steam source.

FIG. 7 is a diagram of an embodiment of the gasification system of the invention having a single feedstock processing unit, a single catalyst loading unit, three heat exchangers, two acid gas removal units, and two methane removal units, and including each of the optional unit operations.

### DETAILED DESCRIPTION

The present disclosure relates to systems for converting a carbonaceous feedstock into a plurality of gaseous products including at least methane, the systems comprising, among other units, three separate gasification reactors for the conversion of the carbonaceous feedstock in the presence of an alkali metal catalyst into the plurality of gaseous products. In particular, the present systems provide improved gasification systems having at least three gasification reactors which share one or more unit operations to facilitate, for example, routine maintenance or repair while maintaining systems operations, with improved operating efficiency and control of the overall system.

Each of the gasification reactors may be supplied with the carbonaceous feedstock from a single or separate catalyst loading and/or feedstock preparation unit operations. Similarly, the hot gas streams from each gasification reactor may be purified via their combination at a heat exchanger, acid gas removal, or methane removal unit operations. Product purification may comprise optional trace contaminant removal units, ammonia removal and recovery units, and sour shift units. There may be one, two or three of each type of unit depending on system configuration, as discussed in further detail below.

The invention can be practiced, for example, using any of the developments to catalytic gasification technology disclosed in commonly-owned US2007/0000177A1; US2007/0083072A1, US2007/0277437A1, US2009/0048476A1, US2009/0090056A1 and US2009/0090055A1.

Moreover, the present invention can be practiced in conjunction with the subject matter disclosed in commonly-owned U.S. patent application Ser. Nos. 12/342,554, 12/342,565, 12/342,578, 12/342,596, 12/342,608, 12/342,628, 12/342,663, 12/342,715, 12/342,736, 12/343,143, 12/343,149 and 12/343,159, each of which was filed 23 Dec. 2008; 12/395,293, 12/395,309, 12/395,320, 12/395,330, 12/395,344, 12/395,348, 12/395,353, 12/395,372, 12/395,381, 12/395,385, 12/395,429, 12/395,433 and 12/395,447, each of which was filed 27 Feb. 2009; and 12/415,042 and 12/415,050, each of which was filed 31 Mar. 2009.

Yet further, the present invention can be practiced in combination with the developments described in the following previously incorporated U.S. patent application Ser. No. ______, attorney docket no. FN-0034 US NP1, entitled TWO-TRAIN CATALYTIC GASIFICATION SYSTEMS; Ser. No. ______, attorney docket no. FN-0036 US NP1 entitled FOUR-TRAIN CATALYTIC GASIFICATION SYSTEMS; Ser. No. ______, attorney docket no. FN-0037 US NP1, entitled FOUR-TRAIN CATALYTIC GASIFICATION SYSTEMS; and Ser. No. ______, attorney docket no. FN-0038 US NP1, entitled FOUR-TRAIN CATALYTIC GASIFICATION SYSTEMS.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Although methods and materials similar or equivalent to those described herein can be used in the practice or testing of the present disclosure, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “substantial portion”, as used herein, unless otherwise defined herein, means that greater than about 90% of the referenced material, preferably greater than 95% of the referenced material, and more preferably greater than 97% of the referenced material. The percent is on a molar basis when reference is made to a molecule (such as methane, carbon dioxide, carbon monoxide and hydrogen sulfide), and otherwise is on a weight basis (such as for entrained carbonaceous fines).

The term “unit” refers to a unit operation. When more than one “unit” is described as being present, those units are operated in a parallel fashion (as depicted in the Figures). A single “unit”, however, may comprise more than one of the units in series. For example, an acid gas removal unit may comprise a hydrogen sulfide removal unit followed in series by a carbon dioxide removal unit. As another example, a trace contaminant removal unit may comprise a first removal unit for a first trace contaminant followed in series by a second removal unit for a second trace contaminant. As yet another example, a methane compressor unit may comprise a first methane compressor to compress the methane product stream to a first pressure, followed in series by a second methane compressor to further compress the methane product stream to a second (higher) pressure.

The materials, methods, and examples herein are illustrative only and, except as specifically stated, are not intended to be limiting.

Multi-Train Configurations

In various embodiments, the present invention provides systems to gasify a catalyzed carbonaceous feedstock in the presence of steam to produce a gaseous product, which is subsequently treated to separate and recover methane. The system is based on three gasification reactors operating in parallel (three gasification trains).

It should be noted that the present invention also includes multiples of the three-train systems, so that an overall plant configuration can, for example, comprise two independent but parallel three-train systems (of the same or different configuration in accordance with the present invention), making a total of six gasification reactors. The three-train systems in accordance with the present invention can also be combined with other independent multiple-train systems, such as disclosed in previously incorporated U.S. patent application Ser. No. ______, attorney docket no. FN-0034 US NP1, entitled TWO-TRAIN CATALYTIC GASIFICATION SYSTEMS; Ser. No. ______, attorney docket no. FN-0036 US NP1, entitled FOUR-TRAIN CATALYTIC GASIFICATION SYSTEMS; Ser. No. ______, attorney docket no. FN-0037 US NP1, entitled FOUR-TRAIN CATALYTIC GASIFICATION SYSTEMS; and Ser. No. ______, attorney docket no. FN-0038 US NP1, entitled FOUR-TRAIN CATALYTIC GASIFICATION SYSTEMS.

In one specific embodiment, denoted as “System A”, the system comprises: (a) the first, second and third gasifying reactor units; (b) the first, second and third catalyst loading units; (c) the single carbonaceous material processing unit; (d) the first, second and third heat exchanger units; (e) the single acid gas remover unit; (f) the single methane removal unit; and (g) the single steam source.

In a specific embodiment of System A, the system further comprises one or more of:

(h) (1) a single trace contaminant removal unit between the first, second and third heat exchanger units and the single acid gas remover unit, to remove at least a substantial portion of one or more trace contaminants from the first, second and third cooled first gas streams; or
(2) a first and a second trace contaminant removal unit between the first, second and third heat exchanger units and the single acid gas remover unit to remove at least a substantial portion of one or more trace contaminants from the first, second and third cooled first gas streams; or
(3) a first, a second and a third trace contaminant removal unit between the first, second and third heat exchanger units and the single acid gas remover unit, to remove at least a substantial portion of one or more trace contaminants from the first, second and third cooled first gas streams;

(i) a single reformer unit to convert a portion of the single methane product stream into a syngas;

(j) a single methane compressor unit to compress at least a portion of the single methane product stream;

(k) a single carbon dioxide recovery unit to separate and recover carbon dioxide removed by the single acid gas remover unit;

(l) a single sulfur recovery unit to extract and recover sulfur from hydrogen sulfide removed by the single acid gas remover unit;

(m) (1) a single catalyst recovery unit to extract and recover at least a portion of the entrained catalyst from at least a portion of the solid char product from the first, second and third gasifying units, and recycle at least a portion of the recovered catalyst to one or more of the first, second and third catalyst loading units; or

(2) a first and a second catalyst recovery unit to extract and recover at least a portion of the entrained catalyst from at least a portion of the solid char product from the first, second and third gasifying units, and recycle at least a portion of the recovered catalyst to one or more of the first, second and third catalyst loading units; or

(3) a first, a second and a third catalyst recovery unit to extract and recover at least a portion of the entrained catalyst from at least a portion of the solid char product from the first, second and third gasifying reactor units, and recycle at least a portion of the recovered catalyst to one or more of the first, second and third catalyst loading units;

(n) a gas recycle loop to recycle at least a portion of the single methane-depleted gas stream to the first, second and third gasifying reactor units;

(o) a waste water treatment unit to treat waste water generated by the system;

(p) a superheater to superheat steam in or from the single steam source;

(q) a steam turbine to generate electricity from a portion of the steam supplied by the single steam source; and

(r) (1) a single sour shift unit between the first, second and third heat exchanger units and the single acid gas remover unit, to convert at least a portion of carbon monoxide in the first, second and third cooled first gas streams to carbon dioxide; or
(2) a first and a second sour shift unit between the first, second and third heat exchanger units and the single acid gas remover unit, to convert at least a portion of carbon monoxide in the first, second and third cooled first gas streams to carbon dioxide; or
(3) a first, a second and a third sour shift unit between the first, second and third heat exchanger units and the single acid gas remover unit, to convert at least a substantial portion of carbon monoxide in the first, second and third cooled first gas streams to carbon dioxide.

In another specific embodiment, denoted as “System B”, the system comprises: (a) the first, second and third gasifying reactor units; (b) the first, second and third catalyst loading units; (c) the single carbonaceous material processing unit; (d) the first, second and third heat exchanger units; (e) the first and second acid gas remover units; (f) the first and second methane removal units; and (g) the single steam source.

In a specific embodiment of System B, the system further comprises one or more of:

(h) (1) a first and a second trace contaminant removal unit between the first, second and third heat exchanger units and the first and second acid gas remover units to remove a substantial portion of one or more trace contaminants from the first, second and third cooled first gas streams; or
(2) a first, a second and a third trace contaminant removal unit between the first, second and third heat exchanger units and the first and second acid gas remover units, to remove a substantial portion of one or more trace contaminants from the first, second and third cooled first gas streams;

(i) (1) a single reformer unit to convert a portion of one or both of the first and second methane product stream into a syngas, or
(2) a first and a second reformer unit to convert a portion of the first and second methane product streams into a syngas;

(j) (1) a single methane compressor unit to compress at least a portion of one or both of the first and second methane product streams, or
(2) a first and a second methane compressor unit to compress at least a portion of the first and second methane product streams;

(k) (1) a single carbon dioxide recovery unit to separate and recover carbon dioxide removed by the first and second acid gas remover units, or
(2) a first and a second carbon dioxide recovery unit to separate and recover carbon dioxide removed by the first and second acid gas remover units;

(l) (1) a single sulfur recovery unit to extract and recover sulfur from hydrogen sulfide removed by the first and second acid gas remover units, or
(2) a first and a second sulfur recovery unit to extract and recover sulfur from hydrogen sulfide removed by the first and second acid gas remover units;

(m) (1) a single catalyst recovery unit to extract and recover at least a portion of the entrained catalyst from at least a portion of the solid char product from the first, second and third gasifying units, and recycle at least a portion of the recovered catalyst to one or more of the first, second and third catalyst loading units; or
(2) a first and a second catalyst recovery unit to extract and recover at least a portion of the entrained catalyst from the at least a portion of the solid char product from the first, second and third gasifying units, and recycle at least a portion of the recovered catalyst to one or more of the first, second and third catalyst loading units; or
(3) a first, a second and a third catalyst recovery unit to extract and recover at least a portion of the entrained catalyst from the solid char product from the first, second and third gasifying reactor units, and recycle at least a portion of the recovered catalyst to one or more of the first, second and third catalyst loading units;

(n) a gas recycle loop to recycle at least a portion of the first and second methane-depleted gas streams to the first, second and third gasifying reactor units;

(o) a waste water treatment unit to treat waste water generated by the system;

(p) a superheater to superheat steam in or from the single steam source;

(q) a steam turbine to generate electricity from a portion of the steam supplied by the single steam source; and

(r) (1) a first and a second sour shift unit between the first, second and third heat exchanger units and the first and second acid gas remover units, to convert at least a substantial portion of carbon monoxide in the first, second and third cooled first gas streams to carbon dioxide; or
(2) a first, a second and a third sour shift unit between the first, second and third heat exchanger units and the first and second acid gas remover units, to convert at least a substantial portion of carbon monoxide in the first, second and third cooled first gas streams to carbon dioxide.

In another specific embodiment of the invention, denoted as “System C”, the system comprises: (a) the first, second and third gasifying reactor units; (b) the single catalyst loading unit; (c) the single carbonaceous material processing unit; (d) the first, second and third heat exchanger units; (e) the single acid gas remover unit; (f) the single methane removal unit; and (g) the single steam source.

In a specific embodiment of System C, the system further comprises one or more of:

(h) (1) a single trace contaminant removal unit between the first, second and third heat exchanger units and the single acid gas remover unit, to remove at least a substantial portion of one or more trace contaminants from the first, second and third cooled first gas streams; or
(2) a first and a second trace contaminant removal unit between the first, second and third heat exchanger units and the single acid gas remover unit, to remove at least a substantial portion of one or more trace contaminants from the first, second and third cooled first gas streams; or
(3) a first, a second and a third trace contaminant removal unit between the first, second and third heat exchanger units and the single acid gas remover unit, to remove at least a substantial portion of one or more trace contaminants from the first, second and third cooled first gas streams;

(i) a single reformer unit to convert a portion of the single methane product stream into a syngas;

(j) a single methane compressor unit to compress at least a portion of the single methane product stream;

(k) a single carbon dioxide recovery unit to separate and recover carbon dioxide removed by the single acid gas remover unit;

(l) a single sulfur recovery unit to extract and recover sulfur from hydrogen sulfide removed by the single acid gas remover unit;

(m) (1) a single catalyst recovery unit to extract and recover at least a portion of the entrained catalyst from at least a portion of the solid char product from the first, second and third gasifying reactor units, and recycle at least a portion of the recovered catalyst to the single catalyst loading unit; or
(2) a first and a second catalyst recovery unit to extract and recover at least a portion of the entrained catalyst from at least a portion of the solid char product from the first, second and third gasifying reactor units, and recycle at least a portion of the recovered catalyst to the single catalyst loading unit; or
(3) a first, second and third catalyst recovery unit to extract and recover at least a portion of the entrained catalyst from at least a portion of the solid char product from the first, second and third gasifying reactor units, and recycle at least a portion of the recovered catalyst to the single catalyst loading unit;

(n) a gas recycle loop to recycle at least a portion of the single methane-depleted gas stream to the first, second and third gasifying reactor units;

(o) a waste water treatment unit to treat waste water generated by the system;

(p) a superheater to superheat steam in or from the single steam source;

(q) a steam turbine to generate electricity from a portion of the steam supplied by the single steam source; and

(r) (1) a single sour shift unit between the first, second and third heat exchanger units and the single acid gas remover unit, to convert at least a portion of carbon monoxide in the first, second and third cooled first gas streams to carbon dioxide; or
(2) a first and a second sour shift unit between the first, second and third heat exchanger units and the single acid gas remover unit, to convert at least a portion of carbon monoxide in the first, second and third cooled first gas streams to carbon dioxide; or
(3) a first, a second and a third sour shift unit between the first, second and third heat exchanger units and the single acid gas remover unit, to convert at least a portion of carbon monoxide in the first, second and third cooled first gas streams to carbon dioxide.

In another specific embodiment of the invention, denoted as “System D”, the system comprises: (a) the first, second and third gasifying reactor units; (b) the first, second and third catalyst loading units; (c) the single carbonaceous material processing unit; (d) the first, second and third heat exchanger units; (e) the first and second acid gas remover units; (f) the single methane removal unit, or the first and second methane removal units; and (g) the single steam source.

In a specific embodiment of System D, the system further comprises one or more of:

(h) (1) a first and a second trace contaminant removal unit between the first, second and third heat exchanger units and the first and second acid gas remover units, to remove at least a substantial portion of one or more trace contaminants from the first, second and third cooled first gas streams; or
(2) a first, a second and a third trace contaminant removal unit between the first, second and third heat exchanger units and the first and second acid gas remover units, to remove at least a substantial portion of one or more trace contaminants from the first, second and third cooled first gas streams;

(i) (1) if only the single methane removal unit is present, a single reformer unit to convert a portion of the single methane product stream into a syngas, or
(2) if the first and second methane removal units are present, (i) a single reformer unit to convert a portion of one or both of the first and second methane product streams into a syngas, or (ii) a first and a second reformer unit to convert a portion of the first and second methane product streams into a syngas;

(j) (1) if only the single methane removal unit is present, a single methane compressor unit to compress at least a portion of the single methane product stream, or
(2) if the first and second methane removal units are present, (i) a single methane compressor unit compress at least a portion of the first and second methane product streams, or (ii) a first and a second methane compressor unit to compress at least a portion of the first and second methane product streams;

(k) (1) a single carbon dioxide recovery unit to separate and recover carbon dioxide removed by the first and second acid gas remover units, or
(2) a first and a second carbon dioxide recovery unit to separate and recover carbon dioxide removed by the first and second acid gas remover units;

(l) (1) a single sulfur recovery unit to extract and recover sulfur from hydrogen sulfide removed by the first and second acid gas remover units, or
(2) a first and a second sulfur recovery unit to extract and recover sulfur from hydrogen sulfide removed by the first and second acid gas remover units;

(m) (1) a single catalyst recovery unit to extract and recover at least a portion of the entrained catalyst from at least a portion of the solid char product from one or more of the first, second and third gasifying reactor units, and recycle at least a portion of the recovered catalyst to one or more of the first, second and third catalyst loading units, or
(2) a first and a second catalyst recovery unit to extract and recover at least a portion of the entrained catalyst from at least a portion of the solid char product from two or more of the first, second and third gasifying reactor units, and recycle at least a portion of the recovered catalyst to one or more of the first, second and third catalyst loading units, or
(3) a first, a second and a third catalyst recovery unit to extract and recover at least a portion of the entrained catalyst from at least a portion of the solid char product from the first, second and third gasifying reactor unit, and recycle at least a portion of the recovered catalyst to one or more of the first, second and third catalyst loading units;

(n) a gas recycle loop to recycle at least a portion of the single methane-depleted gas stream, or the first and second methane-depleted gas streams, to the first, second and third gasifying reactor units;

(o) a waste water treatment unit to treat waste water generated by the system;

(p) a superheater to superheat steam in or from the single steam source;

(q) a steam turbine to generate electricity from a portion of the steam supplied by the single steam source; and

(r) (1) a first and a second single sour shift unit between the first, second and third heat exchanger units and the first and second acid gas remover units, to convert at least a portion of carbon monoxide in the first, second and third cooled first gas streams to carbon dioxide, or

(2) a first, a second and a third sour shift unit between the first, second and third heat exchanger units and the first and second acid gas remover units, to convert at least a substantial portion of carbon monoxide in the first, second and third cooled first gas streams to carbon dioxide.

In another specific embodiment of the invention, denoted as “System E”, the system comprises: (a) the first, second and third gasifying reactor units; (b) the single catalyst loading unit; (c) the single carbonaceous material processing unit; (d) the first, second and third heat exchanger units; (e) the first, second and third acid gas remover units; (f) the single methane removal unit, or the first and second methane removal units; and (g) the single steam source.

In a specific embodiment of System E, the system further comprises one or more of:

(h) a first, a second and a third trace contaminant removal unit between the first, second and third heat exchanger units and the first, second and third acid gas remover units, to remove at least a substantial portion of one or more trace contaminants from the first, second and third cooled first gas stream;

(i) (1) if only the single methane removal unit is present, a single reformer unit to convert a portion of the single methane product stream into a syngas, or
(2) if the first and second methane removal units are present, (i) a single reformer unit to convert a portion of one or both of the first and second methane product streams into a syngas, or (ii) a first and a second reformer unit to convert a portion of the first and second methane product streams into a syngas;

(j) (1) if only the single methane removal unit is present, a single methane compressor unit to compress at least a portion of the single methane product stream, or
(2) if the first and second methane removal units are present, (i) a single methane compressor unit to compress at least a portion of one or both of the first and second methane product streams, or (ii) a first and a second methane compressor unit to compress at least a portion of the first and second methane product streams;

(k) (1) a single carbon dioxide recovery unit to separate and recover carbon dioxide removed by the first, second and third acid gas remover units, or
(2) a first and a second carbon dioxide recovery unit to separate and recover carbon dioxide removed by the first, second and third acid gas remover units, or
(3) a first, a second and a third carbon dioxide recovery unit to separate and recover carbon dioxide removed by the first, second and third acid gas remover units;

(l) (1) a single sulfur recovery unit to extract and recover sulfur from hydrogen sulfide removed by the first, second and third acid gas remover units, or
(2) a first and a second sulfur recovery unit to extract and recover sulfur from hydrogen sulfide removed by the first, second and third acid gas remover units, or
(3) a first, a second and a third sulfur recovery unit to extract and recover sulfur from hydrogen sulfide removed by the first, second and third acid gas remover units;

(m) (1) a single catalyst recovery unit to extract and recover at least a portion of the entrained catalyst from at least a portion of the solid char product from one or more of the first, second and third gasifying reactor units, and recycle at least a portion of the recovered catalyst to the single catalyst loading unit, or
(2) a first and a second catalyst recovery unit to extract and recover at least a portion of the entrained catalyst from at least a portion of the solid char product from two or more of the first, second and third gasifying reactor units, and recycle at least a portion of the recovered catalyst to the single catalyst loading unit, or
(3) a first, a second and a third catalyst recovery unit to extract and recover at least a portion of the entrained catalyst from at least a portion of the solid char product from the first, second and third gasifying reactor units, and recycle at least a portion of the recovered catalyst to the single catalyst loading unit;

(n) a gas recycle loop to recycle at least a portion of the single methane-depleted gas stream, or the first and second methane-depleted gas streams, to the first, second and third gasifying reactor units;

(o) a waste water treatment unit to treat waste water generated by the system;

(p) a superheater to superheat steam in or from the single steam source;

(q) a steam turbine to generate electricity from a portion of the steam supplied by the single steam source; and

(r) a first, a second and a third sour shift unit between the first, second and third heat exchanger units and the first, second and third acid gas remover units, to convert at least a portion of carbon monoxide in the first, second and third cooled first gas streams to carbon dioxide.

In a specific embodiment of any one of Systems A-E, each comprises at least (k), (l) and (m).

In a specific embodiment of any one of the preceding Systems and embodiments thereof, when the system comprises (k), then the system can further comprises a carbon dioxide compressor unit to compress recovered carbon dioxide.

In another specific embodiment of any one of the preceding systems, the system comprises (r) and a trim methanator between an acid gas remover unit and a methane removal unit (to treat an acid gas-depleted gas stream).

In another specific embodiment of any one of the preceding systems and embodiments thereof, when the plurality of gaseous products further comprises ammonia, the system may further comprise:
(1) when only the single heat exchanger unit and the single acid gas remover unit are present, a single ammonia remover unit to remove a substantial portion of the ammonia from the single cooled first gas stream, to produce a single ammonia-depleted cooled first gas stream to feeding to the single acid gas remover unit, or
(2) when only the first and second heat exchanger units and the single acid gas remover unit are present, (i) a single ammonia remover unit between the first and second heat exchanger units and the single acid gas remover unit to removing a substantial portion of the ammonia from the first and second cooled first gas streams to produce a single ammonia-depleted cooled first gas stream for feeding to the single acid gas remover unit, or (ii) a first and a second ammonia remover unit between the first and second heat exchanger units and the single acid gas remover unit, to remove a substantial portion of the ammonia from the first and second cooled first gas streams to produce a first and a second ammonia-depleted cooled first gas stream to feed to the single acid gas remover unit, or
(3) when only the first and second heat exchanger units and the first and second acid gas remover units are present, a first and a second ammonia remover unit between the first and second heat exchanger units and the first and second acid gas remover units, to remove a substantial portion of the ammonia from the first and second cooled first gas stream to produce a first and a second ammonia-depleted cooled first gas stream to feed to the first and second acid gas remover units; or
(4) when the first, second and third heat exchanger units and only the single acid gas remover unit are present, (i) a single ammonia remover unit between the first, second and third heat exchanger units and the single acid gas remover unit to remove a substantial portion of the ammonia from the first, second and third cooled first gas streams to produce a single ammonia-depleted cooled first gas stream to feed to the single acid gas remover unit, or (ii) a first and a second ammonia remover unit between the first, second and third heat exchanger units and the single acid gas remover unit, to remove a substantial portion of the ammonia from the first, second and third cooled first gas streams to produce a first and a second ammonia-depleted cooled first gas stream to feed to the single acid gas remover unit, or (iii) a first, a second and a third ammonia removal unit between the first, second and third heat exchanger units and the single acid gas remover unit, to remove a substantial portion of the ammonia from the first, second and third cooled first gas streams to produce a first, a second and a third ammonia-depleted cooled first gas stream to feed to the single acid gas remover unit, or
(5) when the first, second and third heat exchanger units and only the first and second acid gas remover units are present, (i) a first and a second ammonia remover unit between the first, second and third heat exchanger unit and the first and second acid gas remover units, to remove a substantial portion of the ammonia from the first, second and third cooled first gas streams to produce a first and a second ammonia-depleted cooled first gas stream, to feed to the first and second acid gas remover units, or (ii) a first, a second and a third ammonia remover unit between the first, second and third heat exchangers unit and the first and second acid gas remover units, to remove a substantial portion of the ammonia from the first, second and third cooled first gas streams to produce a first, a second and a third ammonia-depleted cooled first gas stream, to feed to the first and second acid gas remover units, or
(6) when the first, second and third heat exchanger units and the first, second and third acid gas remover units are present, a first, a second and a third ammonia remover unit between the first, second and third heat exchanger units and the first, second and third acid gas remover units, to remove a substantial portion of the ammonia from the first, second and third cooled first gas streams to produce a first, a second and a third ammonia-depleted cooled first gas stream to feed to the first, second and third acid gas remover units.

The individual units are described in further detail below.

### Feedstock and Processing

Carbonaceous Material Processing Unit

Carbonaceous materials can be provided to a carbonaceous material processing unit to convert the carbonaceous material into a form suitable for association with one or more gasification catalysts and/or suitable for introduction into a catalytic gasification reactor. The carbonaceous material can be, for example, biomass and non-biomass materials as defined below.

The term “biomass” as used herein refers to carbonaceous materials derived from recently (for example, within the past 100 years) living organisms, including plant-based biomass and animal-based biomass. For clarification, biomass does not include fossil-based carbonaceous materials, such as coal. For example, see previously incorporated U.S. patent application Ser. Nos. 12/395,429, 12/395,433 and 12/395,447.

The term “plant-based biomass” as used herein means materials derived from green plants, crops, algae, and trees, such as, but not limited to, sweet sorghum, bagasse, sugarcane, bamboo, hybrid poplar, hybrid willow, albizia trees, eucalyptus, alfalfa, clover, oil palm, switchgrass, sudangrass, millet, jatropha, and miscanthus (e.g., Miscanthus x giganteus). Biomass further include wastes from agricultural cultivation, processing, and/or degradation such as corn cobs and husks, corn stover, straw, nut shells, vegetable oils, canola oil, rapeseed oil, biodiesels, tree bark, wood chips, sawdust, and yard wastes.

The term “animal-based biomass” as used herein means wastes generated from animal cultivation and/or utilization. For example, biomass includes, but is not limited to, wastes from livestock cultivation and processing such as animal manure, guano, poultry litter, animal fats, and municipal solid wastes (e.g., sewage).

The term “non-biomass”, as used herein, means those carbonaceous materials which are not encompassed by the term “biomass” as defined herein. For example, non-biomass include, but is not limited to, anthracite, bituminous coal, sub-bituminous coal, lignite, petroleum coke, asphaltenes, liquid petroleum residues or mixtures thereof. For example, see previously incorporated U.S. patent application Ser. Nos. 12/342,565, 12/342,578, 12/342,608, 12/342,663, 12/395,348 and 12/395,353.

The terms “petroleum coke” and “petcoke” as used here includes both (i) the solid thermal decomposition product of high-boiling hydrocarbon fractions obtained in petroleum processing (heavy residues—“resid petcoke”); and (ii) the solid thermal decomposition product of processing tar sands (bituminous sands or oil sands—“tar sands petcoke”). Such carbonization products include, for example, green, calcined, needle and fluidized bed petcoke.

Resid petcoke can also be derived from a crude oil, for example, by coking processes used for upgrading heavy-gravity residual crude oil, which petcoke contains ash as a minor component, typically about 1.0 wt % or less, and more typically about 0.5 wt % of less, based on the weight of the coke. Typically, the ash in such lower-ash cokes comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes comprises materials such as silica and/or alumina.

Petroleum coke has an inherently low moisture content, typically, in the range of from about 0.2 to about 2 wt % (based on total petroleum coke weight); it also typically has a very low water soaking capacity to allow for conventional catalyst impregnation methods. The resulting particulate compositions contain, for example, a lower average moisture content which increases the efficiency of downstream drying operation versus conventional drying operations.

The petroleum coke can comprise at least about 70 wt % carbon, at least about 80 wt % carbon, or at least about 90 wt % carbon, based on the total weight of the petroleum coke. Typically, the petroleum coke comprises less than about 20 wt % percent inorganic compounds, based on the weight of the petroleum coke.

The term “asphaltene” as used herein is an aromatic carbonaceous solid at room temperature, and can be derived, from example, from the processing of crude oil and crude oil tar sands.

The term “coal” as used herein means peat, lignite, sub-bituminous coal, bituminous coal, anthracite, or mixtures thereof. In certain embodiments, the coal has a carbon content of less than about 85%, or less than about 80%, or less than about 75%, or less than about 70%, or less than about 65%, or less than about 60%, or less than about 55%, or less than about 50% by weight, based on the total coal weight. In other embodiments, the coal has a carbon content ranging up to about 85%, or up to about 80%, or up to about 75% by weight, based on the total coal weight. Examples of useful coal include, but are not limited to, Illinois #6, Pittsburgh #8, Beulah (ND), Utah Blind Canyon, and Powder River Basin (PRB) coals. Anthracite, bituminous coal, sub-bituminous coal, and lignite coal may contain about 10 wt %, from about 5 to about 7 wt %, from about 4 to about 8 wt %, and from about 9 to about 11 wt %, ash by total weight of the coal on a dry basis, respectively. However, the ash content of any particular coal source will depend on the rank and source of the coal, as is familiar to those skilled in the art. See, for example, “Coal Data: A Reference”, Energy Information Administration, Office of Coal, Nuclear, Electric and Alternate Fuels, U.S. Department of Energy, DOE/EIA-0064(93), February 1995.

The ash produced from a coal typically comprises both a fly ash and a bottom ash, as are familiar to those skilled in the art. The fly ash from a bituminous coal can comprise from about 20 to about 60 wt % silica and from about 5 to about 35 wt % alumina, based on the total weight of the fly ash. The fly ash from a sub-bituminous coal can comprise from about 40 to about 60 wt % silica and from about 20 to about 30 wt % alumina, based on the total weight of the fly ash. The fly ash from a lignite coal can comprise from about 15 to about 45 wt % silica and from about 20 to about 25 wt % alumina, based on the total weight of the fly ash. See, for example, Meyers, et al. “Fly Ash. A Highway Construction Material.” Federal Highway Administration, Report No. FHWA-IP-76-16, Washington, D.C., 1976.

The bottom ash from a bituminous coal can comprise from about 40 to about 60 wt % silica and from about 20 to about 30 wt % alumina, based on the total weight of the bottom ash. The bottom ash from a sub-bituminous coal can comprise from about 40 to about 50 wt % silica and from about 15 to about 25 wt % alumina, based on the total weight of the bottom ash. The bottom ash from a lignite coal can comprise from about 30 to about 80 wt % silica and from about 10 to about 20 wt % alumina, based on the total weight of the bottom ash. See, for example, Moulton, Lyle K. “Bottom Ash and Boiler Slag,” Proceedings of the Third International Ash Utilization Symposium. U.S. Bureau of Mines, Information Circular No. 8640, Washington, D.C., 1973.

Each carbonaceous material processing unit can independently comprise one or more receivers to receive and store each carbonaceous material; and a size reduction element, such as a grinder to grind the carbonaceous materials into the carbonaceous particulates, the size reduction element, such as a grinder, in communication with the receiver.

In the event of the use of more than one carbonaceous material processing unit, each may have capacity to handle greater than the proportional total volume of carbonaceous material supplied to provide backup capacity in the event of failure or maintenance. For example, in the event of two carbonaceous material processing units, each may be designed to provide two-thirds or three-quarters or all of the total capacity. In the event of three carbonaceous material processing units, each may be designed to provide one-half or two-thirds or three-quarters of the total capacity.

Carbonaceous materials, such as biomass and non-biomass, can be prepared via crushing and/or grinding, either separately or together, according to any methods known in the art, such as impact crushing and wet or dry grinding to yield one or more carbonaceous particulates. Depending on the method utilized for crushing and/or grinding of the carbonaceous material sources, the resulting carbonaceous particulates in may be sized (i.e., separated according to size) to provide a processed feedstock for the catalyst loading unit operation.

Any method known to those skilled in the art can be used to size the particulates. For example, sizing can be performed by screening or passing the particulates through a screen or number of screens. Screening equipment can include grizzlies, bar screens, and wire mesh screens. Screens can be static or incorporate mechanisms to shake or vibrate the screen. Alternatively, classification can be used to separate the carbonaceous particulates. Classification equipment can include ore sorters, gas cyclones, hydrocyclones, rake classifiers, rotating trommels or fluidized classifiers. The carbonaceous materials can be also sized or classified prior to grinding and/or crushing.

The carbonaceous particulate can be supplied as a fine particulate having an average particle size of from about 25 microns, or from about 45 microns, up to about 2500 microns, or up to about 500 microns. One skilled in the art can readily determine the appropriate particle size for the carbonaceous particulates. For example, when a fluid bed gasification reactor is used, such carbonaceous particulates can have an average particle size which enables incipient fluidization of the carbonaceous materials at the gas velocity used in the fluid bed gasification reactor.

Additionally, certain carbonaceous materials, for example, corn stover and switchgrass, and industrial wastes, such as saw dust, either may not be amenable to crushing or grinding operations, or may not be suitable for use in the catalytic gasification reactor, for example due to ultra fine particle sizes. Such materials may be formed into pellets or briquettes of a suitable size for crushing or for direct use in, for example, a fluid bed catalytic gasification reactor. Generally, pellets can be prepared by compaction of one or more carbonaceous material, see for example, previously incorporated U.S. patent application Ser. No. 12/395,381. In other examples, a biomass material and a coal can be formed into briquettes as described in U.S. Pat. No. 4,249,471, U.S. Pat. No. 4,152,119 and U.S. Pat. No. 4,225,457. Such pellets or briquettes can be used interchangeably with the preceding carbonaceous particulates in the following discussions.

Additional feedstock processing steps may be necessary depending on the qualities of carbonaceous material sources. Biomass may contain high moisture contents, such as green plants and grasses, and may require drying prior to crushing. Municipal wastes and sewages also may contain high moisture contents which may be reduced, for example, by use of a press or roll mill (e.g., U.S. Pat. No. 4,436,028). Likewise, non-biomass such as high-moisture coal, can require drying prior to crushing. Some caking coals can require partial oxidation to simplify gasification reactor operation. Non-biomass feedstocks deficient in ion-exchange sites, such as anthracites or petroleum cokes, can be pre-treated to create additional ion-exchange sites to facilitate catalyst loading and/or association. Such pre-treatments can be accomplished by any method known to the art that creates ion-exchange capable sites and/or enhances the porosity of the feedstock (see, for example, previously incorporated U.S. Pat. No. 4,468,231 and GB 1599932). Oxidative pre-treatment can be accomplished using any oxidant known to the art.

The ratio of the carbonaceous materials in the carbonaceous particulates can be selected based on technical considerations, processing economics, availability, and proximity of the non-biomass and biomass sources. The availability and proximity of the sources for the carbonaceous materials can affect the price of the feeds, and thus the overall production costs of the catalytic gasification process. For example, the biomass and the non-biomass materials can be blended in at about 5:95, about 10:90, about 15:85, about 20:80, about 25:75, about 30:70, about 35:65, about 40:60, about 45:55, about 50:50, about 55:45, about 60:40, about 65:35, about 70:20, about 75:25, about 80:20, about 85:15, about 90:10, or about 95:5 by weight on a wet or dry basis, depending on the processing conditions.

Significantly, the carbonaceous material sources, as well as the ratio of the individual components of the carbonaceous particulates, for example, a biomass particulate and a non-biomass particulate, can be used to control other material characteristics of the carbonaceous particulates. Non-biomass materials, such as coals, and certain biomass materials, such as rice hulls, typically include significant quantities of inorganic matter including calcium, alumina and silica which form inorganic oxides (i.e., ash) in the gasification reactor. At temperatures above about 500° C. to about 600° C., potassium and other alkali metals can react with the alumina and silica in ash to form insoluble alkali aluminosilicates. In this form, the alkali metal is substantially water-insoluble and inactive as a catalyst. To prevent buildup of the residue in the gasification reactor, a solid purge of char comprising ash, unreacted carbonaceous material, and various alkali metal compounds (both water soluble and water insoluble) can be routinely withdrawn.

In preparing the carbonaceous particulates, the ash content of the various carbonaceous materials can be selected to be, for example, about 20 wt % or less, or about 15 wt % or less, or about 10 wt % or less, or about 5 wt % or less, depending on, for example, the ratio of the various carbonaceous materials and/or the starting ash in the various carbonaceous materials. In other embodiments, the resulting the carbonaceous particulates can comprise an ash content ranging from about 5 wt %, or from about 10 wt %, to about 20 wt %, or to about 15 wt %, based on the weight of the carbonaceous particulate. In other embodiments, the ash content of the carbonaceous particulate can comprise less than about 20 wt %, or less than about 15 wt %, or less than about 10 wt %, or less than about 8 wt %, or less than about 6 wt % alumina, based on the weight of the ash. In certain embodiments, the carbonaceous particulates can comprise an ash content of less than about 20 wt %, based on the weight of processed feedstock where the ash content of the carbonaceous particulate comprises less than about 20 wt % alumina, or less than about 15 wt % alumina, based on the weight of the ash.

Such lower alumina values in the carbonaceous particulates allow for, ultimately, decreased losses of alkali catalysts in the gasification process. As indicated above, alumina can react with alkali source to yield an insoluble char comprising, for example, an alkali aluminate or aluminosilicate. Such insoluble char can lead to decreased catalyst recovery (i.e., increased catalyst loss), and thus, require additional costs of make-up catalyst in the overall gasification process.

Additionally, the resulting carbonaceous particulates can have a significantly higher % carbon, and thus btu/lb value and methane product per unit weight of the carbonaceous particulate. In certain embodiments, the resulting carbonaceous particulates can have a carbon content ranging from about 75 wt %, or from about 80 wt %, or from about 85 wt %, or from about 90 wt %, up to about 95 wt %, based on the combined weight of the non-biomass and biomass.

In one example, a non-biomass and/or biomass is wet ground and sized (e.g., to a particle size distribution of from about 25 to about 2500 μm) and then drained of its free water (i.e., dewatered) to a wet cake consistency. Examples of suitable methods for the wet grinding, sizing, and dewatering are known to those skilled in the art; for example, see previously incorporated US2009/0048476A1. The filter cakes of the non-biomass and/or biomass particulates formed by the wet grinding in accordance with one embodiment of the present disclosure can have a moisture content ranging from about 40% to about 60%, or from about 40% to about 55%, or below 50%. It will be appreciated by one of ordinary skill in the art that the moisture content of dewatered wet ground carbonaceous materials depends on the particular type of carbonaceous materials, the particle size distribution, and the particular dewatering equipment used. Such filter cakes can be thermally treated, as described herein, to produce one or more reduced moisture carbonaceous particulates which are passed to the catalyst loading unit operation.

Each of the one or more carbonaceous particulates passed onto the catalyst loading unit operation can have a unique composition, as described above. For example, two carbonaceous particulates can be passed onto the catalyst loading unit operation, where a first carbonaceous particulate comprises one or more biomass materials and the second carbonaceous particulate comprises one or more non-biomass materials. Alternatively, a single the carbonaceous particulate comprising one or more carbonaceous materials can be passed onto the catalyst loading unit operation.

Catalyst Loading Unit

The one or more carbonaceous particulates are further processed in one or more catalyst loading units to associate at least one gasification catalyst, typically comprising a source of at least one alkali metal, with at least one of the carbonaceous particulates to form at least one catalyst-treated feedstock stream.

The catalyzed carbonaceous feedstock for each gasification reactor can be provided by a single catalyst loading unit to the feed inlets of the first, second, and third gasification reactor units; or each of the first, second, and third gasifying reactor units can be supplied with catalyzed carbonaceous feedstock from a first, second and third catalyst loading unit, respectively. When two or more catalyst loading units are utilized, they should operate in parallel.

When a single catalyst loading unit is utilized, that unit supplies the catalyzed carbonaceous feedstock to the feed inlets of the first, second and third gasifying reactor units.

In another variation, a first and a second catalyst loading unit can supply the catalyzed carbonaceous feedstock to the feed inlets of the first, second and third gasifying reactor units. For example, a first catalyst loading unit can supply the catalyzed carbonaceous feedstock to the feed inlet of one or two of the first, second and third gasifying reactor units, and a second catalyst loading unit can supply the catalyzed carbonaceous feedstock to the feed inlet of those of the first, second and third gasifying reactor units (one or two) not supplied by the first catalyst loading unit.

In the event of the use of more than one catalyst loading unit, each may have capacity to handle greater than the proportional total volume of feedstock supplied to provide backup capacity in the event of failure or maintenance. For example, in the event of two catalyst loading units, each may be designed to provide two-thirds or three-quarters of the total capacity. In the event of three catalyst loading units, each may be designed to provide one-half or two-thirds of the total capacity.

When the carbonaceous particulate is provided to the catalyst loading unit operation, it can be either treated to form a single catalyzed carbonaceous feedstock which is passed to each of the gasification reactors, or split into one or more processing streams, where at least one of the processing streams is associated with a gasification catalyst to form at least one catalyst-treated feedstock stream. The remaining processing streams can be, for example, treated to associate a second component therewith. Additionally, the catalyst-treated feedstock stream can be treated a second time to associate a second component therewith. The second component can be, for example, a second gasification catalyst, a co-catalyst, or other additive.

In one example, the primary gasification catalyst can be provided to the single carbonaceous particulate (e.g., a potassium and/or sodium source), followed by a separate treatment to provide a calcium source to the same single carbonaceous particulate to yield the catalyzed carbonaceous feedstock. For example, see previously incorporated U.S. patent application Ser. No. 12/395,372. The gasification catalyst and second component can also be provided as a mixture in a single treatment to the single carbonaceous particulate to yield the catalyzed carbonaceous feedstock.

When one or more carbonaceous particulates are provided to the catalyst loading unit operation, then at least one of the carbonaceous particulates is associated with a gasification catalyst to form at least one catalyst-treated feedstock stream. Further, any of the carbonaceous particulates can be split into one or more processing streams as detailed above for association of a second component therewith. The resulting streams can be blended in any combination to provide the catalyzed carbonaceous feedstock, provided at least one catalyst-treated feedstock stream is utilized to form the catalyzed feedstock stream.

In one embodiment, at least one carbonaceous particulate is associated with a gasification catalyst and optionally, a second component. In another embodiment, each carbonaceous particulate is associated with a gasification catalyst and optionally, a second component.

Any methods known to those skilled in the art can be used to associate one or more gasification catalysts with any of the carbonaceous particulates and/or processing streams. Such methods include but are not limited to, admixing with a solid catalyst source and impregnating the catalyst onto the processed carbonaceous material. Several impregnation methods known to those skilled in the art can be employed to incorporate the gasification catalysts. These methods include but are not limited to, incipient wetness impregnation, evaporative impregnation, vacuum impregnation, dip impregnation, ion exchanging, and combinations of these methods.

In one embodiment, an alkali metal gasification catalyst can be impregnated into one or more of the carbonaceous particulates and/or processing streams by slurrying with a solution (e.g., aqueous) of the catalyst in a loading tank. When slurried with a solution of the catalyst and/or co-catalyst, the resulting slurry can be dewatered to provide a catalyst-treated feedstock stream, again typically, as a wet cake. The catalyst solution can be prepared from any catalyst source in the present methods, including fresh or make-up catalyst and recycled catalyst or catalyst solution. Methods for dewatering the slurry to provide a wet cake of the catalyst-treated feedstock stream include filtration (gravity or vacuum), centrifugation, and a fluid press.

One particular method suitable for combining a coal particulate and/or a processing stream comprising coal with a gasification catalyst to provide a catalyst-treated feedstock stream is via ion exchange as described in previously incorporated US2009/0048476A1. Catalyst loading by ion exchange mechanism can be maximized based on adsorption isotherms specifically developed for the coal, as discussed in the incorporated reference. Such loading provides a catalyst-treated feedstock stream as a wet cake. Additional catalyst retained on the ion-exchanged particulate wet cake, including inside the pores, can be controlled so that the total catalyst target value can be obtained in a controlled manner. The catalyst loaded and dewatered wet cake may contain, for example, about 50 wt % moisture. The total amount of catalyst loaded can be controlled by controlling the concentration of catalyst components in the solution, as well as the contact time, temperature and method, as can be readily determined by those of ordinary skill in the relevant art based on the characteristics of the starting coal.

In another example, one of the carbonaceous particulates and/or processing streams can be treated with the gasification catalyst and a second processing stream can be treated with a second component (see previously incorporated US2007/0000177A1).

The carbonaceous particulates, processing streams, and/or catalyst-treated feedstock streams resulting from the preceding can be blended in any combination to provide the catalyzed carbonaceous feedstock, provided at least one catalyst-treated feedstock stream is utilized to form the catalyzed carbonaceous feedstock. Ultimately, the catalyzed carbonaceous feedstock is passed onto the gasification reactors.

Generally, each catalyst loading unit comprises at least one loading tank to contact one or more of the carbonaceous particulates and/or processing streams with a solution comprising at least one gasification catalyst, to form one or more catalyst-treated feedstock streams. Alternatively, the catalytic component may be blended as a solid particulate into one or more carbonaceous particulates and/or processing streams to form one or more catalyst-treated feedstock streams.

Typically, the gasification catalyst is present in the catalyzed carbonaceous feedstock in an amount sufficient to provide a ratio of alkali metal atoms to carbon atoms in the particulate composition ranging from about 0.01, or from about 0.02, or from about 0.03, or from about 0.04, to about 0.10, or to about 0.08, or to about 0.07, or to about 0.06.

With some feedstocks, the alkali metal component may also be provided within the catalyzed carbonaceous feedstock to achieve an alkali metal content of from about 3 to about 10 times more than the combined ash content of the carbonaceous material in the catalyzed carbonaceous feedstock, on a mass basis.

Suitable alkali metals are lithium, sodium, potassium, rubidium, cesium, and mixtures thereof. Particularly useful are potassium sources. Suitable alkali metal compounds include alkali metal carbonates, bicarbonates, formates, oxalates, amides, hydroxides, acetates, or similar compounds. For example, the catalyst can comprise one or more of sodium carbonate, potassium carbonate, rubidium carbonate, lithium carbonate, cesium carbonate, sodium hydroxide, potassium hydroxide, rubidium hydroxide or cesium hydroxide, and particularly, potassium carbonate and/or potassium hydroxide.

Optional co-catalysts or other catalyst additives may be utilized, such as those disclosed in the previously incorporated references.

The one or more catalyst-treated feedstock streams that are combined to form the catalyzed carbonaceous feedstock typically comprise greater than about 50%, greater than about 70%, or greater than about 85%, or greater than about 90% of the total amount of the loaded catalyst associated with the catalyzed carbonaceous feedstock. The percentage of total loaded catalyst that is associated with the various catalyst-treated feedstock streams can be determined according to methods known to those skilled in the art.

Separate carbonaceous particulates, catalyst-treated feedstock streams, and processing streams can be blended appropriately to control, for example, the total catalyst loading or other qualities of the catalyzed carbonaceous feedstock, as discussed previously. The appropriate ratios of the various stream that are combined will depend on the qualities of the carbonaceous materials comprising each as well as the desired properties of the catalyzed carbonaceous feedstock. For example, a biomass particulate stream and a catalyzed non-biomass particulate stream can be combined in such a ratio to yield a catalyzed carbonaceous feedstock having a predetermined ash content, as discussed previously.

Any of the preceding catalyst-treated feedstock streams, processing streams, and processed feedstock streams, as one or more dry particulates and/or one or more wet cakes, can be combined by any methods known to those skilled in the art including, but not limited to, kneading, and vertical or horizontal mixers, for example, single or twin screw, ribbon, or drum mixers. The resulting catalyzed carbonaceous feedstock can be stored for future use or transferred to one or more feed operations for introduction into the gasification reactors. The catalyzed carbonaceous feedstock can be conveyed to storage or feed operations according to any methods known to those skilled in the art, for example, a screw conveyer or pneumatic transport.

Further, each catalyst loading unit comprises a dryer to remove excess moisture from the catalyzed carbonaceous feedstock. For example, the catalyzed carbonaceous feedstock may be dried with a fluid bed slurry drier (i.e., treatment with superheated steam to vaporize the liquid), or the solution thermally evaporated or removed under a vacuum, or under a flow of an inert gas, to provide a catalyzed carbonaceous feedstock having a residual moisture content, for example, of about 10 wt % or less, or of about 8 wt % or less, or about 6 wt % or less, or about 5 wt % or less, or about 4 wt % or less.

### Gasification

Gasification Reactors

In the present systems, the catalyzed carbonaceous feedstock is provided to three gasification reactors under conditions suitable for conversion of the carbonaceous materials in the catalyzed carbonaceous feedstock to the desired product gases, such as methane.

Each of the gasification reactors individually comprises (A1) a reaction chamber in which a catalyzed carbonaceous feedstock and steam are converted to (i) a plurality of gaseous products comprising methane, hydrogen, carbon monoxide, carbon dioxide, hydrogen sulfide and unreacted steam, (ii) unreacted carbonaceous fines and (iii) a solid char product; (A2) a feed inlet to supply the catalyzed carbonaceous feedstock into the reaction chamber; (A3) a steam inlet to supply steam into the reaction chamber; (A4) a hot gas outlet to exhaust a hot first gas stream out of the reaction chamber, the hot first gas stream comprising the plurality of gaseous products; (A5) a char outlet to withdraw the solid char product from the reaction chamber; and (A6) a fines remover unit to remove at least a substantial portion of the unreacted carbonaceous fines that may be entrained in the hot first gas stream.

The gasification reactors for such processes are typically operated at moderately high pressures and temperature, requiring introduction of the catalyzed carbonaceous feedstock to the reaction chamber of the gasification reactor while maintaining the required temperature, pressure, and flow rate of the feedstock.

Those skilled in the art are familiar with feed inlets to supply the catalyzed carbonaceous feedstock into the reaction chambers having high pressure and/or temperature environments, including, star feeders, screw feeders, rotary pistons, and lock-hoppers. It should be understood that the feed inlets can include two or more pressure-balanced elements, such as lock hoppers, which would be used alternately. In some instances, the catalyzed carbonaceous feedstock can be prepared at pressures conditions above the operating pressure of gasification reactor. Hence, the particulate composition can be directly passed into the gasification reactor without further pressurization.

Any of several catalytic gasification reactors can be utilized. Suitable gasification reactors include those having a reaction chamber which is a counter-current fixed bed, a co-current fixed bed, a fluidized bed, or an entrained flow or moving bed reaction chamber.

Gasification is typically affected at moderate temperatures of at least about 450° C., or of at least about 600° C. or of at least about 650° C., to about 900° C., or to about 800° C., or to about 750° C.; and at pressures of at least about 50 psig, or at least about 200 psig, or at least about 400 psig, to about 1000 psig, or to about 700 psig, or to about 600 psig.

The gas utilized in the gasification reactor for pressurization and reactions of the particulate composition typically comprises steam, and optionally, oxygen or air (or recycle gas), and is supplied to the reactor according to methods known to those skilled in the art. The small amount of required heat input for the catalytic gasification reaction can be provided by any method known to one skilled in the art. For example, introduction of a controlled portion of purified oxygen or air into each gasification reactor can be used to combust a portion of the carbonaceous material in the catalyzed carbonaceous feedstock, thereby providing a heat input.

Reaction of the catalyzed carbonaceous feedstock under the described conditions provides a hot first gas and a solid char product from each of the gasification reactors. The solid char product typically comprises quantities of unreacted carbonaceous material and entrained catalyst, and can be removed from the reaction chamber for sampling, purging, and/or catalyst recovery via the char outlet.

The term “entrained catalyst” as used herein means chemical compounds comprising an alkali metal component. For example, “entrained catalyst” can include, but is not limited to, soluble alkali metal compounds (such as alkali carbonates, alkali hydroxides, and alkali oxides) and/or insoluble alkali compounds (such as alkali aluminosilicates). The nature of catalyst components associated with the char extracted from a catalytic gasification reactor and methods for their recovery are discussed below, and in detail in previously incorporated US2007/0277437A1; and U.S. patent application Ser. Nos. 12/342,554, 12/342,715, 12/342,736 and 12/343,143.

The solid char product can be periodically withdrawn from each of the gasification reactors through a char outlet which is a lock hopper system, although other methods are known to those skilled in the art. Such char may be passed to a catalyst recovery unit operation, as described below. Methods for removing solid char product are well known to those skilled in the art. One such method taught by EP-A-0102828, for example, can be employed.

Hot first gas effluent leaving each reaction chamber can pass through a fines remover unit portion of the gasification reactor which serves as a disengagement zone where particles too heavy to be entrained by the gas leaving the gasification reactor (i.e., fines) are returned to the reaction chamber (e.g., fluidized bed). The fines remover unit can include one or more internal cyclone separators or similar devices to remove fines and particulates from the hot first gas. The hot first gas effluent passing through the fines remover unit and leaving the gasification reactor via the hot gas outlet generally contains CH₄, CO₂, H₂, CO, H₂S, NH₃, unreacted steam, entrained fines, and other contaminants such as COS, HCN and/or elemental mercury vapor.

Residual entrained fines can be substantially removed by any suitable device such as external cyclone separators optionally followed by Venturi scrubbers. The recovered fines can be processed to recover alkali metal catalyst, or directly recycled back to feedstock preparation as described in previously incorporated U.S. patent application Ser. No. 12/395,385.

Removal of a “substantial portion” of fines means that an amount of fines is removed from the hot first gas stream such that downstream processing is not adversely affected; thus, at least a substantial portion of fines should be removed. Some minor level of ultrafine material may remain in hot first gas stream to the extent that downstream processing is not significantly adversely affected. Typically, at least about 90 wt %, or at least about 95 wt %, or at least about 98 wt %, of the fines of a particle size greater than about 20 μm, or greater than about 10 μm, or greater than about 5 μm, are removed.

Catalyst Recovery Unit

In certain embodiments, the alkali metal in the entrained catalyst in the solid char product withdrawn from the reaction chamber of each gasification reactor can be recovered, and any unrecovered catalyst can be compensated by a catalyst make-up stream. The more alumina and silica that is in the feedstock, the more costly it is to obtain a higher alkali metal recovery.

In one embodiment, one or more of the solid char products from each of the gasification reactors can be quenched with recycle gas and water to extract a portion of the entrained catalyst. The recovered catalyst can be directed to the catalyst loading operation for reuse of the alkali metal catalyst. The depleted char can, for example, be directed to any one or more of the feedstock preparation operations for reuse in preparation of the catalyzed feedstock, combusted to power one or more steam generators (such as disclosed in previously incorporated U.S. patent application Ser. Nos. 12/343,149 and 12/395,320), or used as such in a variety of applications, for example, as an absorbent (such as disclosed in previously incorporated U.S. patent application Ser. No. 12/395,293).

Other particularly useful recovery and recycling processes are described in U.S. Pat. No. 4,459,138, as well as previously incorporated US2007/0277437A1; and U.S. patent application Ser. Nos. 12/342,554, 12/342,715, 12/342,736 and 12/343,143. Reference can be had to those documents for further process details.

Typically, in the operation of the system, at least a portion of the entrained catalyst will be recovered, thus the systems in accordance with the present invention will typically comprise one, two or three catalyst recovery units. When two or more catalyst recovery units are utilized, they should operate in parallel. The amount of catalyst to be recovered and recycled will typically be a function of cost of recovery versus cost of makeup catalyst, and a person of ordinary skill in the art can determine a desired catalyst recovery and recycle level based on overall system economics.

The recycle of catalyst can be to one or a combination of catalyst loading units. For example, all of the recycled catalyst can be supplied to one catalyst loading unit, while another utilizes only makeup catalyst. The levels of recycled versus makeup catalyst can also be controlled on an individual basis from catalyst loading unit to catalyst loading unit.

When a single catalyst recovery unit is utilized, that unit treats a desired portion (or all) of the solid char product form the gasification reactors, and recycles recovered catalyst to the one or more catalyst loading units.

In another variation, a first and a second catalyst recovery unit can be utilized. For example, a first catalyst recovery unit can be used to treat a desired portion of the solid char product from one or two of the first, second and third gasifying reactor units, and the second catalyst recovery unit can be used to treat a desired portion of the solid char product from those of the first, second and third gasifying reactors units not treated by the first catalyst recovery unit. Concurrently, when a single catalyst loading unit is present, both the first and second catalyst recovery units can provide recycled catalyst to the single catalyst loading unit. When more than one catalyst loading unit is present, each catalyst recovery unit can provide recycled catalyst to one or multiple catalyst loading units.

In yet another variation, a first, second and third catalyst recovery unit can be utilized. In such a case, typically each catalyst recovery unit would treat a desired portion of the solid char product from a corresponding one of the gasifying reactor units. Catalyst recycle could, however, be to one or any combination of catalyst loading units that may be present.

In the event of the use of more than one catalyst recovery unit, each may have capacity to handle greater than the proportional total volume of char product supplied to provide backup capacity in the event of failure or maintenance. For example, in the event of two catalyst recovery units, each may be designed to provide two-thirds or three-quarters of the total capacity. In the event of three catalyst recovery units, each may be designed to provide one-half or two-thirds of the total capacity.

Heat Exchanger

The gasification of the carbonaceous feedstock results in first, second and third hot first gas streams exiting, respectively, the first, second and third gasifying reactors. Depending on gasification conditions, the hot first gas streams, each independently, will typically exit the corresponding gasifying reactor at a temperature ranging from about 450° C. to about 900° C. (more typically from about 650° C. to about 800° C.), a pressure of from about 50 psig to about 1000 psig (more typically from about 400 psig to about 600 psig), and a velocity of from about 0.5 ft/sec to about 2.0 ft/sec (more typically from about 1.0 ft/sec to about 1.5 ft/sec).

The first, second and third hot first gas streams can be provided to a single heat exchanger unit to remove heat energy to produce a single cooled first gas stream, or each of the first, second and third hot first gas streams can be provided to any combination of two or three heat exchanger units. Typically, the number of heat exchanger units will be greater than or equal to the number of acid gas removal units.

In one variation, one or more portions of the first, second and third hot first gas streams can be provided to a first heat exchanger unit to generate a first cooled first gas stream, and the remaining portions of the first, second and third hot gas streams can be provided a second heat exchanger unit to produce a second cooled first gas stream. For example, one or two of the first, second and third hot first gas streams can be provided to a first heat exchanger unit, and those of the first, second and third hot first gas streams not provided to the first heat exchanger unit (one or two) can be provided to a second heat exchanger unit. In one specific example, the first and second hot first gas streams can be provided to a first heat exchanger unit to generate a first cooled first gas stream, and the third hot first gas streams can be provided to a second heat exchanger unit to generate a second cooled first gas stream.

In yet another variation, the first, second and third hot first gas streams can be provided to a first, second and third heat exchanger unit, respectively, to generate a first, second and third cooled first gas stream, respectively.

In the event of the use of more than one heat exchanger unit, each may have capacity to handle greater than the proportional total volume of the hot first gas streams provided to provide backup capacity in the event of failure or maintenance. For example, in the event of two heat exchanger units, each may be designed to provide two-thirds or three-quarters or all of the total capacity. In the event of three heat exchanger units, each may be designed to provide one-half or two-thirds or three-quarters of the total capacity.

The heat energy extracted by any one or more of the heat exchanger units, when present, can, for example, be used to generate steam and/or preheat recycle gas.

A resulting cooled first gas streams will typically exit a heat exchanger at a temperature ranging from about 250° C. to about 600° C. (more typically from about 300° C. to about 500° C.), a pressure of from about 50 psig to about 1000 psig (more typically from about 400 psig to about 600 psig), and a velocity of from about 0.5 ft/sec to about 2.5 ft/sec (more typically from about 1.0 ft/sec to about 1.5 ft/sec).

Product Gas Separation and Purification

The one or more cooled first gas streams from the heat exchanger units are then passed to one or more unit operations to separate the various components of the product gas. The one or more cooled first gas streams can be provided directly to one or more acid gas remover units to remove carbon dioxide and hydrogen sulfide (and optionally other trace contaminants), or one or more gas streams can be treated in one or more optional trace removal, sour shift and/or ammonia removal units.

Trace Contaminants Removal Unit

As indicated above, a trace contaminants removal unit is optional and can be used to remove trace contaminants present in a gas stream, such as one or more of COS, Hg and HCN. Typically, a trace contaminant removal unit if present, will be located subsequent to a heat exchanger unit, and will treat a portion of one or more of the cooled first gas streams.

Typically, the number of trace contaminant removal units will be equal to or less than the number of heat exchanger units, and greater than or equal to the number of acid gas removal units.

For example, a single cooled first gas stream can be fed to a single trace contaminants removal unit; or first and second cooled first gas streams can be fed to a single trace contaminants removal unit, or first and second cooled first gas streams can be fed to first and second trace contaminants removal units, respectively; or first, second and third cooled first gas streams can be fed to first, second, and third trace contaminants removal units, respectively.

In another variation, one or more portions of the first, second and third cooled first gas streams can be provided to a first trace contaminants removal unit, and the remaining portions the first, second and third cooled first gas streams can be provided to a second trace contaminants removal unit. For example, one or two of the first, second and third cooled first gas streams can be provided to a first trace contaminants removal unit, and those of the first, second and third cooled first gas streams not provided to the first trace contaminants removal unit can be provided to a second trace contaminants removal unit. In a specific example, the first and second cooled first gas streams can be fed to a first trace contaminants removal unit, and the third cooled first gas stream can be fed to a second trace contaminants removal unit.

In the event of the use of more than one trace contaminants removal unit, each may have capacity to handle greater than the proportional total volume of first cooled gas streams supplied to provide backup capacity in the event of failure or maintenance. For example, in the event of two trace contaminants removal units, each may be designed to provide two-thirds or three-quarters or all of the total capacity. In the event of three trace contaminants removal units, each may be designed to provide one-half or two-thirds or three-quarters of the total capacity.

As is familiar to those skilled in the art, the contamination levels of each of the preceding cooled first gas streams will depend on the nature of the carbonaceous material used for preparing the catalyzed carbonaceous feed stock. For example, certain coals, such as Illinois #6, can have high sulfur contents, leading to higher COS contamination; and other coals, such as Powder River Basin coals, can contain significant levels of mercury which can be volatilized in the gasification reactor.

COS can be removed from the cooled first gas stream, for example, by COS hydrolysis (see, U.S. Pat. No. 3,966,875, U.S. Pat. No. 4,011,066, U.S. Pat. No. 4,100,256, U.S. Pat. No. 4,482,529 and U.S. Pat. No. 4,524,050), passing the cooled first gas stream through particulate limestone (see, U.S. Pat. No. 4,173,465), an acidic buffered CuSO₄ solution (see, U.S. Pat. No. 4,298,584), an alkanolamine absorbent such as methyldiethanolamine, triethanolamine, dipropanolamine, or diisopropanolamine, containing tetramethylene sulfone (sulfolane, see, U.S. Pat. No. 3,989,811); or counter-current washing of the cooled first gas stream with refrigerated liquid CO₂ (see, U.S. Pat. No. 4,270,937 and U.S. Pat. No. 4,609,388).

HCN can be removed from the cooled first gas stream, for example, by reaction with ammonium sulfide or polysulfide to generate CO₂, H₂S and NH₃ (see, U.S. Pat. No. 4,497,784, U.S. Pat. No. 4,505,881 and U.S. Pat. No. 4,508,693), or a two stage wash with formaldehyde followed by ammonium or sodium polysulfide (see, U.S. Pat. No. 4,572,826), absorbed by water (see, U.S. Pat. No. 4,189,307), and/or decomposed by passing through alumina supported hydrolysis catalysts such as MoO₃, TiO₂ and/or ZrO₂ (see, U.S. Pat. No. 4,810,475, U.S. Pat. No. 5,660,807 and U.S. Pat. No. 5,968,465).

Elemental mercury can be removed from the cooled first gas stream, for example, by absorption by carbon activated with sulfuric acid (see, U.S. Pat. No. 3,876,393), absorption by carbon impregnated with sulfur (see, U.S. Pat. No. 4,491,609), absorption by a H₂S-containing amine solvent (see, U.S. Pat. No. 4,044,098), absorption by silver or gold impregnated zeolites (see, U.S. Pat. No. 4,892,567), oxidation to HgO with hydrogen peroxide and methanol (see, U.S. Pat. No. 5,670,122), oxidation with bromine or iodine containing compounds in the presence of SO₂ (see, U.S. Pat. No. 6,878,358), oxidation with a H, Cl and O-containing plasma (see, U.S. Pat. No. 6,969,494), and/or oxidation by a chlorine-containing oxidizing gas (e.g., ClO, see, U.S. Pat. No. 7,118,720).

When aqueous solutions are utilized for removal of any or all of COS, HCN and/or Hg, the waste water generated in the trace contaminants removal units can be directed to a waste water treatment unit.

When present, a trace contaminant removal unit for a particular trace contaminant should remove at least a substantial portion (or substantially all) of that trace contaminant from the cooled first gas stream, typically to levels at or lower than the specification limits of the desired product stream. Typically, a trace contaminant removal unit should remove at least 90%, or at least 95%, or at least 98%, of COS, HCN and/or mercury from a cooled first gas stream.

Sour Shift Unit

The single cooled first gas stream, or when present, the first and second cooled first gas streams, together or separately, or when present, the first, second and third cooled first gas streams, together or separately, can be subjected to a water-gas shift reaction, in one or more sour shift units, in the presence of an aqueous medium (such as steam) to convert a portion of the CO to CO₂ and to increase the fraction of H₂. Typically, the number of sour shift units will be less than or equal to the number of cooled first gas streams to be treated, and greater than or equal to the number of acid gas removal units. The water-gas shift treatment may be performed on the cooled first gas streams passed directly from the heat exchangers or on the cooled first gas streams that have passed through one or more of the trace contaminants removal units.

In another variation, one or more portions of the first, second, and third cooled first gas streams can be provided to a first sour shift unit and the remaining portions of the first, second, and third cooled first gas streams can be provided a second sour shift unit. For example, one, or two of the first, second, and third cooled first gas streams can be provided to a first sour shift unit, and those of the first, second, and third cooled first gas streams not provided to the first sour shift unit (one or two) can be provided to a second sour shift unit. In a specific example, the first and second cooled first gas streams can be provided to a first sour shift unit, and the third cooled first gas stream can be provided to a second sour shift unit.

In the event of the use of more than one sour shift unit, each may have capacity to handle greater than the proportional total volume of the cooled first gas streams provided to provide backup capacity in the event of failure or maintenance. For example, in the event of two sour shift units, each may be designed to provide two-thirds or three-quarters or all of the total capacity. In the event of three sour shift units, each may be designed to provide one-half or two-thirds or three-quarters of the total capacity.

A sour shift process is described in detail, for example, in U.S. Pat. No. 7,074,373. The process involves adding water, or using water contained in the gas, and reacting the resulting water-gas mixture adiabatically over a steam reforming catalyst. Typical steam reforming catalysts include one or more Group VIII metals on a heat-resistant support.

Methods and reactors for performing the sour gas shift reaction on a CO-containing gas stream are well known to those of skill in the art. Suitable reaction conditions and suitable reactors can vary depending on the amount of CO that must be depleted from the gas stream. In some embodiments, the sour gas shift can be performed in a single stage within a temperature range from about 100° C., or from about 150° C., or from about 200° C., to about 250° C., or to about 300° C., or to about 350° C. In these embodiments, the shift reaction can be catalyzed by any suitable catalyst known to those of skill in the art. Such catalysts include, but are not limited to, Fe₂O₃-based catalysts, such as Fe₂O₃—Cr₂O₃ catalysts, and other transition metal-based and transition metal oxide-based catalysts. In other embodiments, the sour gas shift can be performed in multiple stages. In one particular embodiment, the sour gas shift is performed in two stages. This two-stage process uses a high-temperature sequence followed by a low-temperature sequence. The gas temperature for the high-temperature shift reaction ranges from about 350° C. to about 1050° C. Typical high-temperature catalysts include, but are not limited to, iron oxide optionally combined with lesser amounts of chromium oxide. The gas temperature for the low-temperature shift ranges from about 150° C. to about 300° C., or from about 200° C. to about 250° C. Low-temperature shift catalysts include, but are not limited to, copper oxides that may be supported on zinc oxide or alumina. Suitable methods for the sour shift process are described in previously incorporated U.S. patent application Ser. No. 12/415,050.

Steam shifting is often carried out with heat exchangers and steam generators to permit the efficient use of heat energy. Shift reactors employing these features are well known to those of skill in the art. An example of a suitable shift reactor is illustrated in previously incorporated U.S. Pat. No. 7,074,373, although other designs known to those of skill in the art are also effective. Following the sour gas shift procedure, the one or more cooled first gas streams each generally contains CH₄, CO₂, H₂, H₂S, NH₃, and steam.

In some embodiments, it will be desirable to remove a substantial portion of the CO from a cooled first gas stream, and thus convert a substantial portion of the CO. “Substantial” conversion in this context means conversion of a high enough percentage of the component such that a desired end product can be generated. Typically, streams exiting the shift reactor, where a substantial portion of the CO has been converted, will have a carbon monoxide content of about 250 ppm or less CO, and more typically about 100 ppm or less CO.

In other embodiments, it will be desirable to convert only a portion of the CO so as to increase the fraction of H₂ for a subsequent trim methanation, which will typically require an H₂/CO molar ratio of about 3 or greater, or greater than about 3, or about 3.2 or greater. A trim methanator when present will typically be between an acid gas remover unit and a methane removal unit.

Ammonia Recovery Unit

As is familiar to those skilled in the art, gasification of biomass and/or utilizing air as an oxygen source for the gasification reactor can produce significant quantities of ammonia in the cooled first gas stream. Optionally, the single cooled first gas stream, or when present, the first and second cooled first gas streams, together or separately, or when present, the first, second and third cooled first gas streams, together or separately, can be scrubbed by water in one or more ammonia recovery units to recovery ammonia from each of the streams. The ammonia recovery treatment may be performed on the cooled first gas streams passed directly from the heat exchangers or on the cooled first gas streams that have passed through either one or both of (i) one or more of the trace contaminants removal units; and (ii) one or more sour shift units.

In another variation, one or more portions of the first, second and third cooled first gas streams can be provided to a first ammonia recovery unit and the remaining portions of the first, second, and/or third cooled first gas streams can be provided a second ammonia recovery unit. For example, one or two of the first, second and third cooled first gas streams can be provided to a first ammonia recovery unit, and those of the first, second and third cooled first gas streams not provided to the first ammonia recovery unit (one or two) can be provided to a second ammonia recovery unit. In a specific example, the first and second cooled first gas streams can be provided to a first ammonia recovery unit, and the third cooled first gas stream can be provided to a second ammonia recovery unit.

In the event of the use of more than one ammonia recovery unit, each may have capacity to handle greater than the proportional total volume of the cooled first gas streams provided to provide backup capacity in the event of failure or maintenance. For example, in the event of two ammonia recovery units, each may be designed to provide two-thirds or three-quarters of the total capacity. In the event of three ammonia recovery units, each may be designed to provide one-half or two-thirds of the total capacity.

After scrubbing, the one or more cooled first gas streams can comprise at least H₂S, CO₂, CO, H₂ and CH₄. When the one or more cooled first gas streams have previously passed through one or more sour shift units, then, after scrubbing, the one or more cooled first gas streams can comprise at least H₂S, CO₂, H₂ and CH₄.

Ammonia can be recovered from the scrubber water according to methods known to those skilled in the art, can typically be recovered as an aqueous solution (e.g., 20 wt %). The waste scrubber water can be forwarded to a waste water treatment unit.

When present, an ammonia removal unit should remove at least a substantial portion (and substantially all) of the ammonia from the cooled first gas stream. “Substantial” removal in the context of ammonia removal means removal of a high enough percentage of the component such that a desired end product can be generated. Typically, an ammonia removal unit will remove at least about 95%, or at least about 97%, of the ammonia content of a cooled first gas stream.

Acid Gas Removal Unit

A subsequent acid gas removal unit can be used to remove a substantial portion of H₂S and CO₂ from the single or, when present, the first and second cooled first gas streams, together or separately, or, when present, the first, second and third cooled first gas streams, together or separately, utilizing a physical absorption method involving solvent treatment of the gas streams in an acid gas removal unit to give one or more acid gas-depleted gas streams. The acid gas removal processes may be performed on the cooled first gas streams passed directly from the heat exchangers, or on the cooled first gas streams that have passed through either one or more of (i) one or more of the trace contaminants removal units; (ii) one or more sour shift units; and (iii) one or more ammonia recovery units. Each of the acid gas-depleted gas streams generally comprises methane, hydrogen and, optionally, carbon monoxide.

In another variation, one or more portions of the first, second, and third cooled first gas streams can be provided to a first acid gas removal unit and the remaining portions of the first, second, and third cooled first gas streams can be provided a second acid gas removal unit. For example, one or two of the first, second and third cooled first gas streams can be provided to a first acid gas removal unit, and those of the first, second and third cooled first gas streams not provided to the first acid gas remover unit (one or two) can be provided to a second acid gas remover unit. In a specific example, the first and second cooled first gas streams can be provided to a first acid gas remover unit, and the third cooled first gas stream can be provided to a second acid gas remover unit.

In the event of the use of more than one acid gas remover unit, each may have capacity to handle greater than the proportional total volume of the cooled first gas streams provided to provide backup capacity in the event of failure or maintenance. For example, in the event of two acid gas remover units, each may be designed to provide two-thirds or three-quarters or all of the total capacity. In the event of three acid gas remover units, each may be designed to provide one-half or two-thirds or three-quarters of the total capacity.

Acid gas removal processes typically involve contacting the cooled first gas stream with a solvent such as monoethanolamine, diethanolamine, methyldiethanolamine, diisopropylamine, diglycolamine, a solution of sodium salts of amino acids, methanol, hot potassium carbonate or the like to generate CO₂ and/or H₂S laden absorbers. One method can involve the use of Selexol® (UOP LLC, Des Plaines, Ill. USA) or Rectisol® (Lurgi AG, Frankfurt am Main, Germany) solvent having two trains; each train consisting of an H₂S absorber and a CO₂ absorber. The resulting acid gas-depleted gas streams contain CH₄, H₂, and, optionally, CO when the sour shift unit is not part of the process, and typically, small amounts of CO₂ and H₂O. One method for removing acid gases from the cooled first gas stream is described in previously incorporated U.S. patent application Ser. No. 12/395,344.

At least a substantial portion (and substantially all) of the CO₂ and/or H₂S (and other remaining trace contaminants) should be removed via the acid gas removal units. “Substantial” removal in the context of acid gas removal means removal of a high enough percentage of the component such that a desired end product can be generated. The actual amounts of removal may thus vary from component to component. For “pipeline-quality natural gas”, only trace amounts (at most) of H₂S can be present, although higher amounts of CO₂ may be tolerable.

Typically, an acid gas removal unit should remove at least about 85%, or at least about 90%, or at least about 92%, of the CO₂, and at least about 95%, or at least about 98%, or at least about 99.5%, of the H₂S, from a cooled first gas stream.

Losses of desired product (methane) in the acid gas removal step should be minimized such that the acid gas-depleted stream comprises at least a substantial portion (and substantially all) of the methane from the cooled first gas streams. Typically, such losses should be about 2 mol % or less, or about 1.5 mol % or less, or about 1 mol % of less, of the methane from the cooled first gas streams.

Acid Gas Recovery Units

The removal of CO₂ and/or H₂S using one of the solvent-based methods above results in a CO₂-laden absorbent and an H₂S-laden absorbent.

Each of the one or more CO₂-laden absorbents generated by each of the one or more acid gas removal units, respectively, can generally be regenerated in a one or more carbon dioxide recovery units to recover the CO₂ gas; the recovered absorbent can be recycled back to the one or more acid gas removal units. For example, the CO₂-laden absorbent can be passed through a reboiler to separate the extracted CO₂ and absorber. The recovered CO₂ can be compressed and sequestered according to methods known in the art.

Further, each of the one or more H₂S-laden absorbents generated by each of the one or more acid gas removal units, respectively, can generally be regenerated in one or more sulfur recovery to recovery of the H₂S gas; the recovered absorbent can be recycled back to the one or more acid gas removal units. Any recovered H₂S can be converted to elemental sulfur by any method known to those skilled in the art, including the Claus process; the generated sulfur can be recovered as a molten liquid.

Methane Removal Unit

The single acid gas-depleted gas stream can be provided to a single methane removal unit to separate and recover methane from the single acid gas-depleted gas stream to produce a single methane-depleted gas stream and a single methane product stream; or when both first and second acid gas-depleted gas streams are present, then both the first and second acid gas-depleted gas streams can be provided to a single methane removal unit to separate and recover methane from the first and second acid gas-depleted gas streams to produce a single methane-depleted gas stream and a single methane product stream; or when both first and second acid gas-depleted gas streams are present, then the first acid gas-depleted gas stream can be provided to a first methane removal unit to separate and recover methane from the first acid gas-depleted gas stream to produce a first methane-depleted gas stream and a first methane product stream, and the second acid gas-depleted gas stream can be provided to a second methane removal unit to separate and recover methane from the second acid gas-depleted gas stream to produce a second methane-depleted gas stream and a second methane product stream. Further, when present, each of the first, second, and third acid gas-depleted gas streams can be provided to first, second, and third methane removal units, respectively to separate and recover methane from each single acid gas-depleted gas stream to produce first, second, and third methane-depleted gas streams and first, second and third methane product streams, respectively; or each of the first, second, and third acid gas-depleted gas streams can be provided to a single methane removal unit to separate and recover methane from the combined acid gas-depleted gas streams to produce a single methane-depleted gas stream and a single methane product stream.

In another variation, one or more portions of the first, second and third acid gas-depleted gas streams can be provided to a first methane removal unit and the remaining portions of the first, second and third acid gas-depleted gas streams can be provided a second methane removal unit to separate and recover methane from each single acid gas-depleted gas stream to produce a first and second methane-depleted gas streams and a first and second methane product stream, respectively. For example, one or two of the first, second and third acid gas-depleted gas streams can be provided to a first methane removal unit, and those of the first, second and third acid gas-depleted gas streams not provided to the first methane removal unit (one or two) can be provided to a second methane removal unit. In a specific example, the first and second acid gas-depleted gas streams can be provided to a first methane removal unit, and the third acid gas-depleted gas stream can be provided to a second methane removal unit.

In the event of the use of more than one methane removal unit, each may have capacity to handle greater than the proportional total volume of the acid gas-depleted gas streams provided to provide backup capacity in the event of failure or maintenance. For example, in the event of two methane removal units, each may be designed to provide two-thirds or three-quarters of the total capacity. In the event of three methane removal units, each may be designed to provide one-half or two-thirds of the total capacity.

A particularly useful methane product stream is one that qualifies as “pipeline-quality natural gas”, as discussed in further detail below.

Each of the acid gas-depleted gas streams, together or separately, as discussed above, can processed to separate and recover CH₄ by any suitable gas separation method known to those skilled in the art including, but not limited to, cryogenic distillation and the use of molecular sieves or gas separation (e.g., ceramic) membranes. Other methods include via the generation of methane hydrate as disclosed in previously incorporated U.S. patent application Ser. Nos. 12/395,330, 12/415,042 and 12/415,050.

In some embodiments, the methane-depleted gas streams comprise H₂ and CO (i.e., a syngas). In other embodiments, when the optional sour shift unit is present, the gas separation process can produce a methane product stream and a methane-depleted gas stream comprising H₂, as detailed in previously incorporated U.S. patent application Ser. No. 12/415,050. The methane-depleted gas stream can be compressed and recycled to the gasification reactor. Additionally, some of the methane-depleted gas stream can be used as plant fuel (e.g., for use in a combustion turbine). Each of the methane product streams, separately or together, can be compressed and directed to further processes, as necessary, or directed to a gas pipeline.

In some embodiments, the methane product stream, if it contains appreciable amounts of CO, can be further enriched in methane by performing trim methanation to reduce the CO content. One may carry out trim methanation using any suitable method and apparatus known to those of skill in the art, including, for example, the method and apparatus disclosed in U.S. Pat. No. 4,235,044.

The invention provides systems that, in certain embodiments, are capable of generating “pipeline-quality natural gas” from the catalytic gasification of a carbonaceous feedstock. A “pipeline-quality natural gas” typically refers to a natural gas that is (1) within ±5% of the heating value of pure methane (whose heating value is 1010 btu/ft³ under standard atmospheric conditions), (2) substantially free of water (typically a dew point of about −40° C. or less), and (3) substantially free of toxic or corrosive contaminants. In some embodiments of the invention, the methane product stream described in the above processes satisfies such requirements.

Pipeline-quality natural gas can contain gases other than methane, as long as the resulting gas mixture has a heating value that is within ±5% of 1010 btu/ft³ and is neither toxic nor corrosive. Therefore, a methane product stream can comprise gases whose heating value is less than that of methane and still qualify as a pipeline-quality natural gas, as long as the presence of other gases does not lower the gas stream's heating value below 950 btu/scf (dry basis). A methane product stream can, for example, comprise up to about 4 mol % hydrogen and still serve as a pipeline-quality natural gas. Carbon monoxide has a higher heating value than hydrogen; thus, pipeline-quality natural gas could contain even higher percentages of CO without degrading the heating value of the gas stream. A methane product stream that is suitable for use as pipeline-quality natural gas preferably has less than about 1000 ppm CO.

Methane Reformer

If necessary, a portion of any of the methane product streams can be directed to an optional methane reformer and/or a portion of any of the methane product streams can be used as plant fuel (e.g., for use in a combustion turbine). The methane reformer may be included in the process to supplement the recycle carbon monoxide and hydrogen fed to the gasification reactors to ensure that enough recycle gas is supplied to the reactors so that the net heat of reaction is as close to neutral as possible (only slightly exothermic or endothermic), in other words, that the reaction is run under thermally neutral conditions. In such instances, methane can be supplied for the reformer from the methane product, as noted above.

Steam Source

Steam for the gasification reaction is generated by either one, two or three steam sources (generators) for all three reactors. In one alternative, one or two of the first, second and third gasification reactors can be provided with steam from a first steam generator, and those of the first, second and third gasification reactors not provided with steam from a first steam generator (one or two) can be provided with steam from a second steam generator. In a specific example, a first steam generator can provide the steam to the first and second gasification reactors; and a second steam generator can provide steam to the third gasification reactor.

In the event of the use of more than one steam source, each may have capacity to handle greater than the proportional total volume of steam supplied to provide backup capacity in the event of failure or maintenance. For example, in the event of two steam sources, each may be designed to provide two-thirds, three-quarters or even all of the total capacity.

Any of the steam boilers known to those skilled in the art can supply steam to the gasification reactors. Such boilers can be powered, for example, through the use of any carbonaceous material such as powdered coal, biomass etc., and including but not limited to rejected carbonaceous materials from the feedstock preparation operation (e.g., fines, supra). Steam can also be supplied from an additional gasification reactor coupled to a combustion turbine where the exhaust from the reactor is thermally exchanged to a water source and produce steam. Alternatively, the steam may be generated for the gasification reactors as described in previously incorporated U.S. patent application Ser. Nos. 12/343,149, 12/395,309 and 12/395,320.

Steam recycled or generated from other process operations can also be used in combination with the steam from a steam generator to supply steam to the reactor. For example, when the slurried carbonaceous materials are dried with a fluid bed slurry drier, as discussed previously, the steam generated through vaporization can be fed to the gasification reactor. When a heat exchanger unit is used for steam generation that steam can be fed to the gasification reactor as well.

Superheater

The small amount of heat input that may be required for the catalytic gasification reaction can also be provided by optionally superheating any gas provided to each of the gasification reactors. In one example, a mixture of steam and recycle gas feeding each gasification reactor can be superheated by any method known to one skilled in the art. In another example, the steam provided from the stream generator to each gasification reactor can be superheated. In one particular method, compressed recycle gas of CO and H₂ can be mixed with steam from the steam generator and the resulting steam/recycle gas mixture can be further superheated by heat exchange with the gasification reactor effluent followed by superheating in a recycle gas furnace.

Any combination of one to three superheaters may be utilized.

Power Generator

A portion of the steam generated by the steam source may be provided to one or more power generators, such as a steam turbine, to produce electricity which may be either utilized within the plant or can be sold onto the power grid. High temperature and high pressure steam produced within the gasification process may also be provided to a steam turbine for the generation of electricity. For example, the heat energy captured at the heat exchanger in contact with the hot first gas stream can be utilized for the generation of steam which is provided to the steam turbine.

Waste Water Treatment Unit

Residual contaminants in waste water resulting from any one or more or the trace removal unit, sour shift unit, ammonia removal unit, and/or catalyst recovery unit can be removed in a waste water treatment unit to allow recycling of the recovered water within the plant and/or disposal of the water from the plant process according to any methods known to those skilled in the art. Such residual contaminants can comprise, for example, phenols, CO, CO₂, H₂S, COS, HCN, ammonia, and mercury. For example, H₂S and HCN can be removed by acidification of the waste water to a pH of about 3, treating the acidic waste water with an inert gas in a stripping column, increasing the pH to about 10 and treating the waste water a second time with an inert gas to remove ammonia (see U.S. Pat. No. 5,236,557). H₂S can be removed by treating the waste water with an oxidant in the presence of residual coke particles to convert the H₂S to insoluble sulfates which may be removed by flotation or filtration (see U.S. Pat. No. 4,478,425). Phenols can be removed by contacting the waste water with a carbonaceous char containing mono- and divalent basic inorganic compounds (e.g., the solid char product or the depleted char after catalyst recovery, supra) and adjusting the pH (see U.S. Pat. No. 4,113,615). Phenols can also be removed by extraction with an organic solvent followed by treatment of the waste water in a stripping column (see U.S. Pat. No. 3,972,693, U.S. Pat. No. 4,025,423 and U.S. Pat. No. 4,162,902).

### EXAMPLES

### Example 1

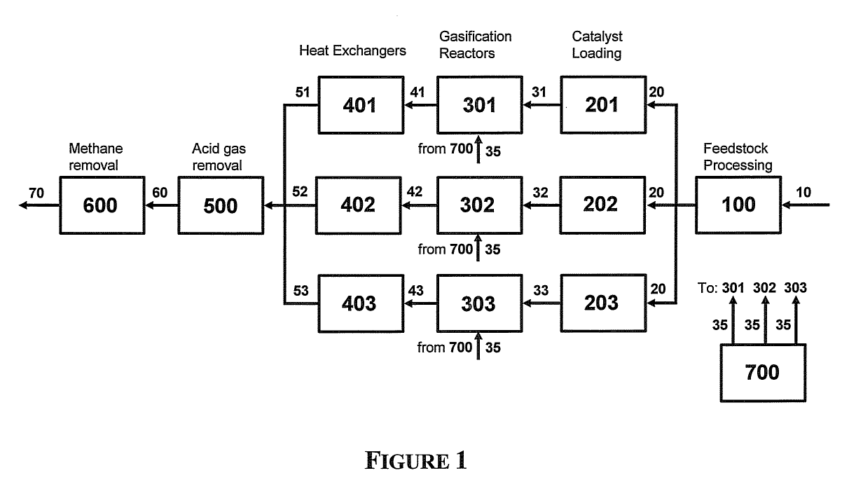

One embodiment of the system of the invention is illustrated in FIG. 1. Therein, the system comprises a single feedstock operation (100); a first (201), second (202) and third (203) catalyst loading unit; a first (301), second (302) and third (303) gasification reactor; a first (401), second (402) and third (403) heat exchanger; a single acid gas removal unit (500); a single (600) methane removal unit; and a single steam source (700).

A carbonaceous feedstock (10) is provided to the feedstock processing unit (100) and is converted to a carbonaceous particulate (20) having an average particle size of less than about 2500 μm. The carbonaceous particulate (20) is provided to each of the first (201), second (202), and third (203) catalyst loading units wherein the particulate is contacted with a solution comprising a gasification catalyst in a loading tank, the excess water removed by filtration, and the resulting wet cakes dried with a drier to provide first (31), second (32), and third (33) catalyzed carbonaceous feedstocks to the first (301), second (302) and third (303) gasification reactors, respectively. In the three gasification reactors, the first (31), second (32), and third (33) catalyzed carbonaceous feedstocks are contacted with steam (35) provided by the common steam source (700) under conditions suitable to convert each feedstock to a first (41), second (42), and third (43) hot first gas streams, respectively, each comprising at least methane, carbon dioxide, carbon monoxide, hydrogen, and hydrogen sulfide. The first (41), second (42), and third (43) hot first gas streams (41) are separately provided to the first (401), second (402), and third (403) heat exchangers to generate first (51), second (52), and third (53) cooled first gas streams, respectively. The first (51), second (52), and third (53) cooled first gas streams are separately provided to the single acid gas removal unit (500) where the hydrogen sulfide and carbon dioxide are removed from the combined streams to generate an acid gas-depleted gas stream (60) comprising methane, carbon monoxide, and hydrogen. Finally, the methane portion of the acid gas-depleted gas stream (60) is removed in the single (600) methane removal unit to ultimately generate a methane product stream (70).

### Example 2

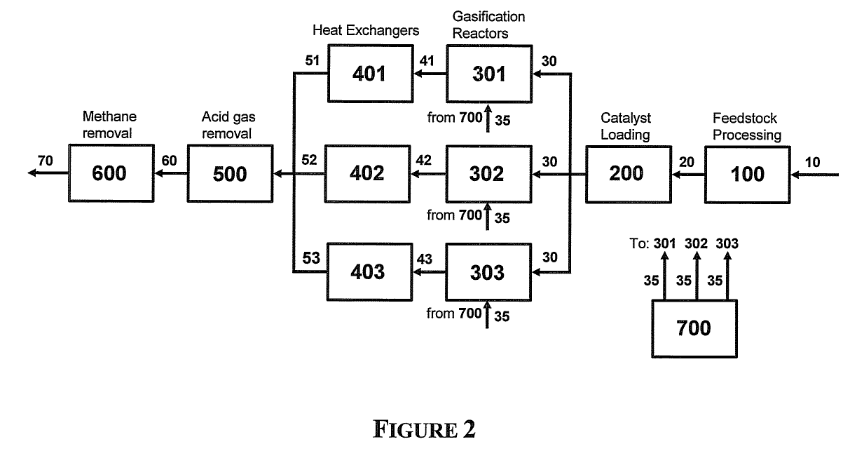

A second embodiment of the system of the invention is illustrated in FIG. 2. Therein, the system comprises a single feedstock operation (100); a single catalyst loading unit (200); a first (301), second (302) and third (303) gasification reactor; a first (401), second (402) and third (403) heat exchanger; a single acid gas removal unit (500); a single methane removal unit (600); and a single steam source (700).

A carbonaceous feedstock (10) is provided to the feedstock processing unit (100) and is converted to a carbonaceous particulate (20) having an average particle size of less than about 2500 μm. The carbonaceous particulate is provided to the single catalyst loading unit (200) wherein the particulate is contacted with a solution comprising a gasification catalyst in a loading tank, the excess water removed by filtration, and the resulting wet cake dried with a drier to provide a catalyzed carbonaceous feedstock (30) to the first (301), second (302) and third (303) gasification reactors. In the three gasification reactors, the catalyzed carbonaceous feedstock (30) is contacted with steam (35) provided by the common steam source (700) under conditions suitable to convert the feedstock to first (41), second (42) and third (43) hot first gas streams, each comprising at least methane, carbon dioxide, carbon monoxide, hydrogen, and hydrogen sulfide. The first (41), second (42) and third (43) hot first gas streams are separately provided to the first (401), second (402) and third (403) heat exchanger units to generate first (51), second (52) and third (53) cooled first gas streams. The first (51), second (52) and third (53) cooled first gas streams are provided to the single acid gas removal unit (500) where the hydrogen sulfide and carbon dioxide are removed from the combined streams to generate a single acid gas-depleted gas stream (60) comprising methane, carbon monoxide, and hydrogen. Finally, the methane portion of the single acid gas-depleted gas stream (60) is removed via the single methane removal unit (600) to ultimately generate a single methane product stream (70).

### Example 3

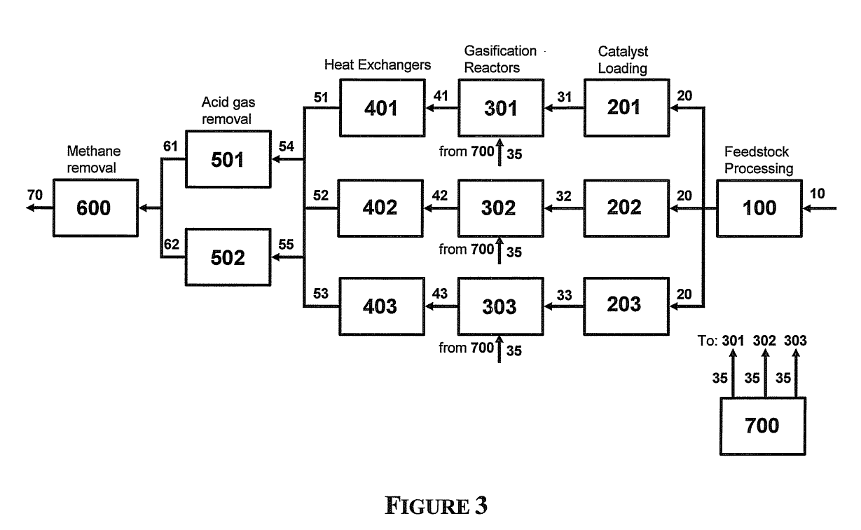

A third embodiment of the system of the invention is illustrated in FIG. 3. Therein, the system comprises a single (100) feedstock operation; a first (201), second (202) and third (203) catalyst loading unit; a first (301), second (302) and third (303) gasification reactor; a first (401), second (402) and third (403) heat exchanger; a first (501) and second (502) acid gas removal unit; a single methane removal unit (600); and a single steam source (700).

A carbonaceous feedstock (10) is provided to the single (100) feedstock processing unit, and converted to a carbonaceous particulate (20) having an average particle size of less than about 2500 μm. The carbonaceous particulate (20) is provided to the first (201), second (202) and third (203) catalyst loading units wherein the particulate is contacted with a solution comprising a gasification catalyst in a loading tank, the excess water removed by filtration, and the resulting wet cake dried with a drier to provide catalyzed carbonaceous feedstocks (31, 32 & 33) to the first (301), second (302) and third (303) gasification reactors, respectively. In the three gasification reactors, the catalyzed carbonaceous feedstock (30) is contacted with steam (35) provided by the single steam source (700) under conditions suitable to convert the feedstock to first (41), second (42) and third (43) hot first gas streams, each comprising at least methane, carbon dioxide, carbon monoxide, hydrogen, and hydrogen sulfide. The first (41), second (42) and third (43) hot first gas streams are separately provided to the first (401), second (402) and third (403) heat exchangers, respectively, to generate first (51), second (52) and third (53) cooled first gas streams. The three cooled gas streams can be combined in any combination thereof to form two cooled gas streams (54, 55), which are separately provided to the first (501) and second (502) acid gas removal units where the hydrogen sulfide and carbon dioxide are removed from each stream to generate first (61) and second (62) acid gas-depleted gas streams, each comprising methane, carbon monoxide, and hydrogen. Finally, the methane portion of the first (61) and second (62) acid gas-depleted gas streams is removed via the single methane removal unit (600) to ultimately generate a single methane product stream (70).

### Example 4

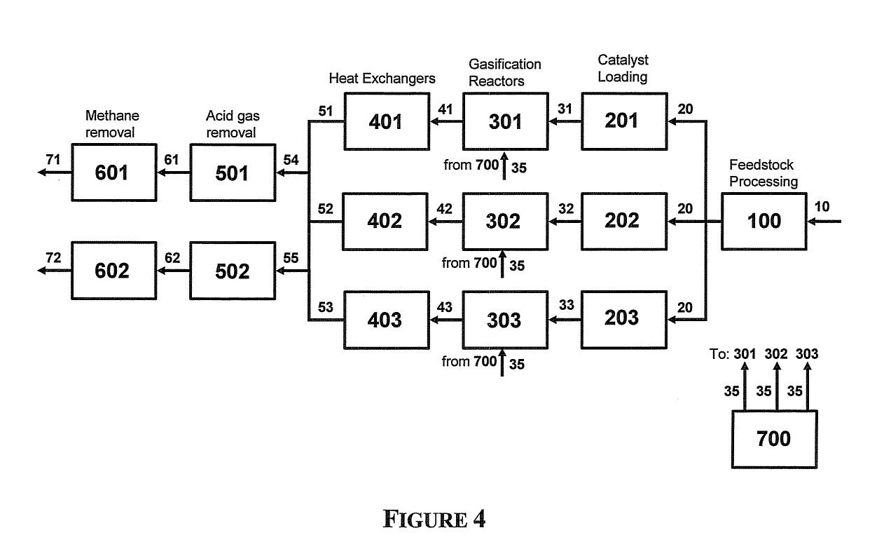

A fourth embodiment of the system of the invention is illustrated in FIG. 4. Therein, the system comprises a single (100) feedstock operation; a first (201), second (202) and third (203) catalyst loading unit; a first (301), second (302) and third (303) gasification reactor; a first (401), second (402) and third (403) heat exchanger; a first (501) and second (502) acid gas removal unit; a single methane removal unit (600); and a single steam source (700).

A carbonaceous feedstock (10) is provided to the single (100) feedstock processing unit, and converted to a carbonaceous particulate (20) having an average particle size of less than about 2500 μm. The carbonaceous particulate (20) is provided to the first (201), second (202) and third (203) catalyst loading units wherein the particulate is contacted with a solution comprising a gasification catalyst in a loading tank, the excess water removed by filtration, and the resulting wet cake dried with a drier to provide catalyzed carbonaceous feedstocks (31, 32 & 33) to the first (301), second (302) and third (303) gasification reactors, respectively. In the three gasification reactors, the catalyzed carbonaceous feedstock (30) is contacted with steam (35) provided by the common steam source (700) under conditions suitable to convert the feedstock to first (41), second (42) and third (43) hot first gas streams, each comprising at least methane, carbon dioxide, carbon monoxide, hydrogen, and hydrogen sulfide. The first (41), second (42) and third (43) hot first gas streams are separately provided to the first (401), second (402) and third (403) heat exchangers respectively, to generate first (51), second (52) and third (53) cooled first gas streams. The three cooled gas streams can be combined in any combination thereof to form two cooled gas streams (54, 55), which are separately provided to the first (501) and second (502) acid gas removal units where the hydrogen sulfide and carbon dioxide are removed from each stream to generate first (61) and second (62) acid gas-depleted gas streams, each comprising methane, carbon monoxide, and hydrogen. Finally, the methane portions of the first (61) and second (62) acid gas-depleted gas streams are removed via the first (601) and second (602) methane removal units to ultimately generate a first (71) and second (72) methane product streams.

### Example 5

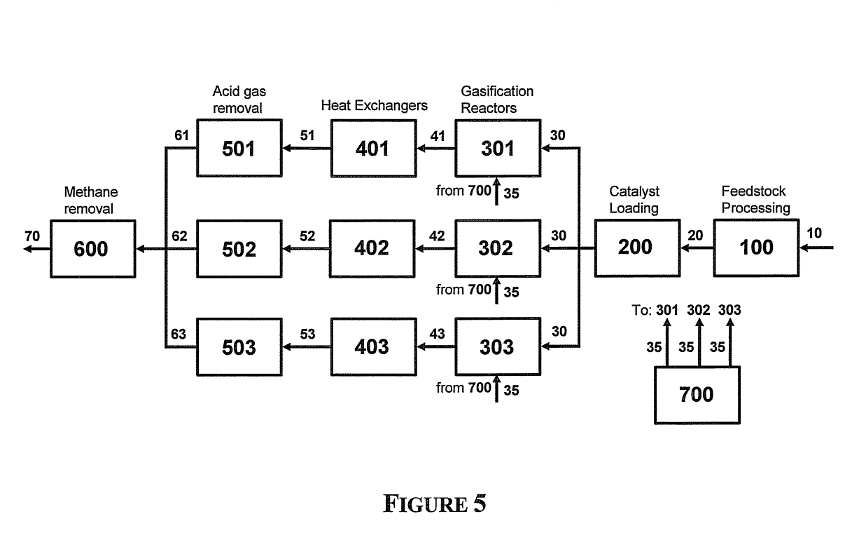

A fifth embodiment of the system of the invention is illustrated in FIG. 5. Therein, the system comprises a single (100) feedstock operation; a single (200) catalyst loading unit; a first (301), second (302) and third (303) gasification reactor; a first (401), second (402) and third (403) heat exchanger; a first (501) and second (502) acid gas removal unit; a single methane removal unit (600); and a single steam source (700).

A carbonaceous feedstock (10) is provided to the single (100) feedstock processing unit, and converted to a carbonaceous particulate (20) having an average particle size of less than about 2500 μm. The carbonaceous particulate (20) is provided to the single (200) catalyst loading unit wherein the particulate is contacted with a solution comprising a gasification catalyst in a loading tank, the excess water removed by filtration, and the resulting wet cake dried with a drier to provide a catalyzed carbonaceous feedstock (30) to the first (301), second (302) and third (303) gasification reactors. In the three gasification reactors, the catalyzed carbonaceous feedstock (30) is contacted with steam (35) provided by the common steam source (700) under conditions suitable to convert the feedstock to first (41), second (42) and third (43) hot first gas streams, each comprising at least methane, carbon dioxide, carbon monoxide, hydrogen, and hydrogen sulfide. The first (41), second (42) and third (43) hot first gas streams are separately provided to the first (401), second (402) and third (403) heat exchangers, respectively, to generate first (51), second (52) and third (53) cooled first gas streams. The first (51), second (52) and third (53) cooled gas streams are separately provided to the first (501), second (502) and third (503) acid gas removal units where the hydrogen sulfide and carbon dioxide are removed from the each stream to generate first (61), second (62) and third (63) acid gas-depleted gas streams, each comprising methane, carbon monoxide, and hydrogen. Finally, the methane portions of the first (61), second (62) and third (63) acid gas-depleted gas streams are removed via the single methane removal unit (600) to ultimately generate a methane product stream (70).

### Example 6

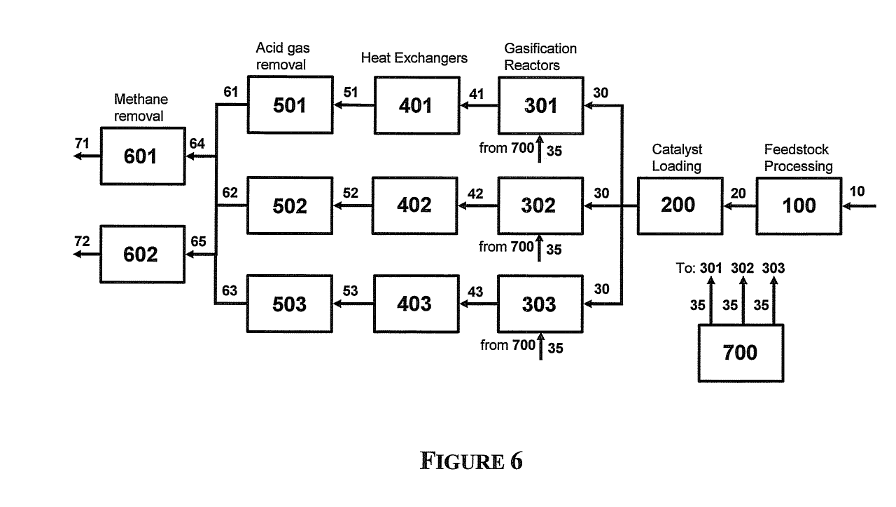

A sixth embodiment of the system of the invention is illustrated in FIG. 6. Therein, the system comprises a single (100) feedstock operation; a single (200) catalyst loading unit; a first (301), second (302) and third (303) gasification reactor; a first (401), second (402) and third (403) heat exchanger; a first (501) and second (502) acid gas removal unit; a single methane removal unit (600); and a single steam source (700).

A carbonaceous feedstock (10) is provided to the single (100) feedstock processing unit, and converted to a carbonaceous particulate (20) having an average particle size of less than 2500 μm. The carbonaceous particulate (20) is provided to the single (200) catalyst loading unit wherein the particulate is contacted with a solution comprising a gasification catalyst in a loading tank, the excess water removed by filtration, and the resulting wet cake dried with a drier to provide a catalyzed carbonaceous feedstock (30) to the first (301), second (302) and third (303) gasification reactors. In the three gasification reactors, the catalyzed carbonaceous feedstock (30) is contacted with steam (35) provided by the common steam source (700) under conditions suitable to convert the feedstock to first (41), second (42) and third (43) hot first gas streams, each comprising at least methane, carbon dioxide, carbon monoxide, hydrogen, and hydrogen sulfide. The first (41), second (42) and third (43) hot first gas streams are separately provided to the first (401), second (402) and third (403) heat exchanger, respectively, to generate first (51), second (52), and third (53) cooled first gas streams. The first (51), second (52) and third (53) cooled gas streams are separately provided to the first (501), second (502) and third (503) acid gas removal units where the hydrogen sulfide and carbon dioxide are removed from the each stream to generate first (61), second (62) and third (63) acid gas-depleted gas streams, each comprising methane, carbon monoxide, and hydrogen. The three acid gas-depleted gas streams can be combined in any combination thereof to form two acid gas-depleted gas streams (64, 65), which are separately provided to the first (601) and second (602) methane removal units to ultimately generate first (71) and second (72) methane product streams.

### Example 7

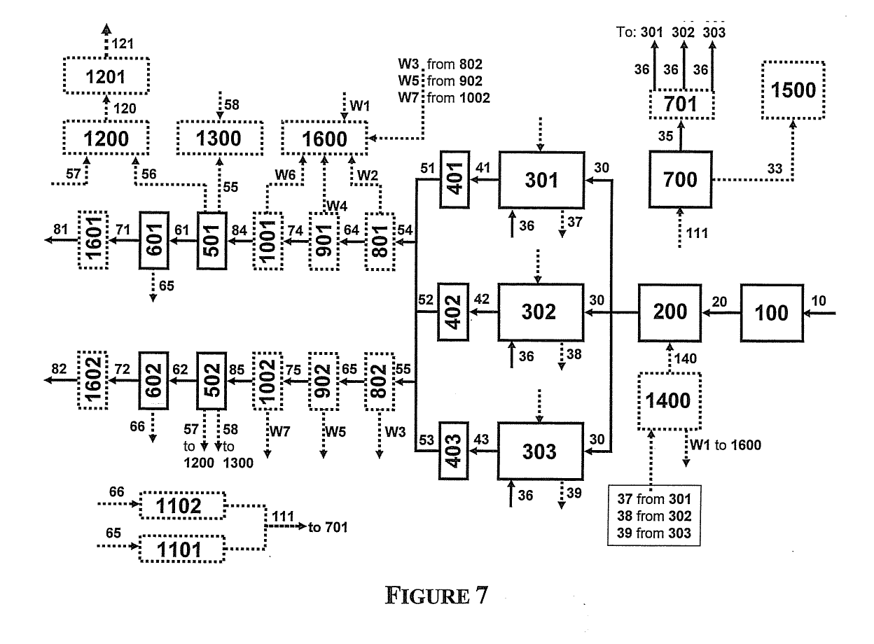

A seventh embodiment of the system of the invention is illustrated in FIG. 7. Therein, the system comprises a single feedstock operation (100); a single catalyst loading unit (200); a first (301), second (302) and third (303) gasification reactor; a first (401), second (402) and third (403) heat exchanger; a first (501) and second (502) acid gas removal unit; a first (601) and second (602) methane removal unit; a first (801) and second (802) trace contaminant removal unit; a first (901) and second (902) sour shift unit; a first (1001) and second (1002) ammonia removal unit; a first (1101) and second (1102) reformer; a CO₂ recovery unit (1200); a sulfur recovery unit (1300); a catalyst recovery unit (1400); a waste water treatment unit (1600); and a single steam source (700) in communication with a superheater (701) and a steam turbine (1500).

A carbonaceous feedstock (10) is provided to the feedstock processing unit (100) and is converted to a carbonaceous particulate (20) having an average particle size of less than about 2500 μm. The carbonaceous particulate is provided to the single catalyst loading unit (200) wherein the particulate is contacted with a solution comprising a gasification catalyst in a loading tank, the excess water removed by filtration, and the resulting wet cake dried with a drier to provide a catalyzed carbonaceous feedstock (30) to the first (301), second (302) and third (303) gasification reactors. In the three gasification reactors, the catalyzed carbonaceous feedstock (30) is contacted with superheated steam (36) provided by the common steam source (700) providing steam (35) to a superheater (701), under conditions suitable to convert the feedstock to a first (41), second (42) and third (43) hot first gas stream, each comprising at least methane, carbon dioxide, carbon monoxide, hydrogen, hydrogen sulfide, COS, ammonia, HCN and mercury. A portion of the steam (33) generated by the steam source (700) is directed to the steam turbine (1500) to generate electricity. Each of the first (301), second (302) and third (303) gasification reactors generates a first (37), second (38) and third (39) solid char product, comprising entrained catalyst, which is periodically removed from their respective reaction chambers and directed to the catalyst recovery operation (1400) where the entrained catalyst is recovered (140) and returned to the catalyst loading operation (200). Waste water generated in the catalyst recovery operation (W1) is directed to the waste water treatment unit (1600) for neutralization and/or purification, as necessary.

The first (41), second (42) and third (43) hot first gas streams are each provided to the first (401), second (402) and third (403) heat exchangers, respectively, to generate first (51), second (52) and third (53) cooled first gas streams. The three cooled gas streams can be combined in any combination thereof to form two cooled gas streams (54, 55) which are separately provided to the first (801) and second (802) trace contaminant removal units, respectively, where the HCN, mercury and COS are removed from each to generate first (64) and second (65) trace-depleted cooled first gas streams comprising at least methane, carbon dioxide, carbon monoxide, hydrogen, ammonia and hydrogen sulfide. Any waste water generated by the trace contaminant removal units (W2, W3) is directed to the waste water treatment unit (1600).

The first (64) and second (65) trace-depleted cooled first gas streams are separately directed to the first (901) and second (902) sour shift units where the carbon monoxide in each stream is substantially converted to CO₂ to provide first (74) and second (75) sweet trace-depleted cooled first gas streams comprising at least methane, carbon dioxide, hydrogen, ammonia and hydrogen sulfide. Any waste water generated by the sour shift units (W4, W5) is directed to the waste water treatment unit (1600).

The first (74) and second (75) sweet trace-depleted cooled first gas streams are separately provided to the first (1001) and second (1002) ammonia removal units, where the ammonia is removed from each stream to generate first (84) and second (85) sweet trace and ammonia-depleted cooled first gas streams comprising at least methane, carbon dioxide, hydrogen and hydrogen sulfide. Any waste water generated by the ammonia removal units (W6, W7) is directed to the waste water treatment unit (1600).

The first (84) and second (85) sweet trace and ammonia-depleted cooled first gas streams are separately provided to the first (501) and second (502) acid gas removal units where the hydrogen sulfide and carbon dioxide in each stream are removed by sequential absorption by contacting the streams with H₂S and CO₂ absorbers, to generate first (61) and second (62) acid gas-depleted gas streams comprising at least methane and hydrogen, and H₂S— (55, 58) and CO₂-laden (56, 57) absorbers. The H₂S-laden absorbers (55, 58) are directed to the sulfur recovery unit (1300) where the absorbed H₂S is recovered from the H₂S-laden absorbers (55, 58) and converted via a Claus process to sulfur. The regenerated H₂S absorber can be recycled back to one or both of the acid gas removal units (501, 502) (not shown). The CO₂-laden absorbers (56, 57) are directed to the carbon dioxide recovery unit (1200) where the absorbed CO₂ is recovered from the CO₂-laden absorbers (56, 57); the regenerated CO₂ absorber can be recycled back to one or both of the acid gas removal units (501, 502) (not shown). The recovered CO₂ (120) can be compressed at the carbon dioxide compressor unit (1201) to an appropriate pressure for sequestration (121).

Finally, the methane portions of the first (61) and second (62) acid gas-depleted gas streams are removed via the first (601) and second (602) methane removal units to generate first (71) and second (72) methane product streams and first (65) and second (66) methane-depleted gas streams. The first (71) and second (72) methane product streams are compressed at the first (1601) and second (1602) methane compressor units to an appropriate pressure for providing to a gas pipeline (81, 82). The methane-depleted gas streams (65 and 66) are directed to the first (1101) and second (1102) reformers, respectively, where the methane in the streams is converted to a syngas (111) which is provided via a gas recycle loop and superheater (701) to the first (301), second (302) and third (303) gasification reactors to maintain essentially thermally neutral conditions within each gasification reactor.

We claim:

1. A gasification system to generate a plurality of gases from a catalyzed carbonaceous feedstock, the system comprising:
(a) a first, a second and a third gasifying reactor unit, wherein each gasifying reactor unit independently comprises:
(A1) a reaction chamber in which a catalyzed carbonaceous feedstock and steam are converted to (i) a plurality of gaseous products comprising methane, hydrogen, carbon monoxide, carbon dioxide, hydrogen sulfide and unreacted steam, (ii) unreacted carbonaceous fines; and (iii) a solid char product comprising entrained catalyst;
(A2) a feed inlet to supply the catalyzed carbonaceous feedstock into the reaction chamber;
(A3) a steam inlet to supply steam into the reaction chamber;
(A4) a hot gas outlet to exhaust a hot first gas stream out of the reaction chamber, the hot first gas stream comprising the plurality of gaseous products;
(A5) a char outlet to withdraw the solid char product from the reaction chamber; and
(A6) a fines remover unit to remove at least a substantial portion of the unreacted carbonaceous fines that may be entrained in the hot first gas stream;
(b) (1) a single catalyst loading unit to supply the catalyzed carbonaceous feedstock to the feed inlets of the first, second and third gasifying reactor units, or
(2) a first catalyst loading unit and a second catalyst loading unit to supply the catalyzed carbonaceous feedstock to the feed inlets of the first, second and third gasifying reactor units, or
(3) a first, a second and a third catalyst loading unit to supply the catalyzed carbonaceous feedstock to the feed inlets of the first, second and third gasifying reactor units,
wherein each catalyst loading unit independently comprises:
(B1) a loading tank to receive carbonaceous particulates and load catalyst onto the carbonaceous particulates to form the catalyzed carbonaceous feedstock; and
(B2) a dryer to thermally treat the catalyzed carbonaceous feedstock to reduce moisture content;
(c) (1) when only the single catalyst loading unit is present, a single carbonaceous material processing unit to supply the carbonaceous particulates to the loading tank of the single catalyst loading unit, or
(2) when only the first and second catalyst loading units are present, (i) a single carbonaceous material processing unit to supply the carbonaceous particulates to the loading tanks of the first and second catalyst loading units, or (ii) a first and a second carbonaceous material processing unit to supply the carbonaceous particulates to the loading tanks of the first and second catalyst loading units, or
(3) when the first, second and third catalyst loading units are present, (i) a single carbonaceous material processing unit to supply the carbonaceous particulates to the loading tanks of the first, second and third catalyst loading units, or (ii) a first and a second carbonaceous material processing unit to supply the carbonaceous particulates to the loading tanks of the first, second and third catalyst loading units, or (iii) a first, a second and a third carbonaceous material processing unit to supply the carbonaceous particulates to the loading tanks of the first, second and third catalyst loading units,
wherein each carbonaceous material processing unit independently comprises:
(C1) a receiver to receive and store a carbonaceous material; and
(C2) a grinder in communication with the receiver to grind the carbonaceous material into the carbonaceous particulates;
(d) (1) a single heat exchanger unit to remove heat energy from the hot first gas streams from the first, second and third gasifying reactor units to generate steam and produce a single cooled first gas stream, or
(2) a first and a second heat exchanger unit to remove heat energy from the hot first gas streams from the first, second and third gasifying reactor units to generate steam and produce a first cooled first gas stream and a second cooled first gas stream, or
(3) a first, a second and a third heat exchanger unit to remove heat energy from the hot first gas stream from the first, second and third gasifying reactor units to generate steam and produce a first cooled first gas stream, a second cooled first gas stream, and a third cooled first gas stream;
(e) (1) when only the single heat exchanger unit is present, a single acid gas remover unit to remove at least a substantial portion of the carbon dioxide and at least a substantial portion of the hydrogen sulfide from the single cooled first gas stream, to produce a single acid gas-depleted gas stream comprising at least a substantial portion of the methane, at least a substantial portion of the hydrogen, and, optionally, at least a portion of the carbon monoxide from the single cooled first gas stream, or
(2) when only the first and second heat exchanger units are present, (i) a single acid gas remover unit to remove at least a substantial portion of the carbon dioxide and at least a substantial portion of the hydrogen sulfide from the first and second cooled first gas streams, to produce a single acid gas-depleted gas stream comprising at least a substantial portion of the methane, at least a substantial portion of the hydrogen, and, optionally, at least a portion of the carbon monoxide from the first and second cooled gas streams, or (ii) a first and a second acid gas remover unit to remove at least a substantial portion of the carbon dioxide and at least a substantial portion of the hydrogen sulfide from the first and second cooled first gas streams, to produce a first acid gas-depleted gas stream and a second acid gas-depleted gas stream comprising at least a substantial portion of the methane, at least a substantial portion of the hydrogen, and, optionally, at least a portion of the carbon monoxide from the first and second cooled gas streams, or
(3) when the first, second and third heat exchanger units are present, (i) a single acid gas remover unit to remove at least a substantial portion of the carbon dioxide and at least a substantial portion of the hydrogen sulfide from the first, second and third cooled gas streams, to produce a single acid gas-depleted gas stream comprising at least a substantial portion of the methane, at least a substantial portion of the hydrogen, and, optionally, at least a portion of the carbon monoxide from the first, second and third cooled gas streams, or (ii) a first and a second acid gas remover unit to remove at least a substantial portion of the carbon dioxide and at least a substantial portion of the hydrogen sulfide from the first, second and third cooled first gas streams, to produce a first acid gas-depleted gas stream and a second acid gas-depleted gas stream, wherein the first and second acid gas-depleted gas streams together comprise at least a substantial portion of the methane, at least a substantial portion of the hydrogen and, optionally, at least a portion of the carbon monoxide from the first, second and third cooled first gas streams, or (iii) a first, a second and a third acid gas remover unit to remove at least a substantial portion of the carbon dioxide and at least a substantial portion of the hydrogen sulfide from the first, second and third cooled first gas streams to produce a first acid gas-depleted gas stream, a second acid gas-depleted gas stream and a third acid gas-depleted gas stream, wherein the first, second and third acid gas-depleted gas streams together comprise at least a substantial portion of the methane, at least a substantial portion of the hydrogen, and, optionally, at least a portion of the carbon monoxide from the first, second and third cooled first gas stream;
(f) (1) when only the single acid gas-depleted gas stream is present, a single methane removal unit to separate and recover methane from the single acid gas-depleted gas stream, to produce a single methane-depleted gas stream and a single methane product stream, the single methane product stream comprising at least a substantial portion of the methane from the single acid gas-depleted stream, or
(2) when only the first and second acid gas-depleted gas streams are present, (i) a single methane removal unit to separate and recover methane from the first and second acid gas-depleted gas streams, to produce a single methane-depleted gas stream and a single methane product stream, the single methane product stream comprising at least a substantial portion of the methane from the first and second acid gas-depleted streams, or (ii) a first and a second methane removal unit to separate and recover methane from the first and second acid gas-depleted gas streams, to produce a first methane-depleted gas stream and a first methane product stream, and a second methane-depleted gas stream and a second methane product stream, the first and second methane product streams together comprising at least a substantial portion of the methane from the first and second acid gas-depleted streams, or
(3) when the first, second and third acid gas-depleted gas streams are present, (i) a single methane removal unit to separate and recover methane from the first, second and third acid gas-depleted gas streams, to produce a single methane-depleted gas stream and a single methane product stream, the single methane product stream comprising at least a substantial portion of the methane from the first, second and third acid gas-depleted streams, or (ii) a first and a second methane removal unit to separate and recover methane from the first, second and third acid gas-depleted gas streams, to produce a first methane-depleted gas stream and a first methane product stream, and a second methane-depleted gas stream and a second methane product stream, the first and second methane product streams together comprising at least a substantial portion of the methane from the first, second and third acid gas-depleted streams, or (iii) a first, a second and a third methane removal unit to separate and recover methane from the first, second and third acid gas-depleted gas streams, to produce a first methane-depleted gas stream and a first methane product stream, a second methane-depleted gas stream and a second methane product stream, and a third methane-depleted gas stream and a third methane product stream, the first, second and third methane product stream together comprising at least a substantial portion of the methane from the first, second and third acid gas-depleted streams; and
(g) (1) a single steam source to supply steam to the first, second and third gasifying reactor units, or
(2) a first and a second steam source to supply steam to the first, second, and third gasifying reactor units; or
(3) a first, a second and a third steam source to supply steam to the first, second and third gasifying reactor units.

2. The system according to claim 1, wherein the system further comprises one or more of:
(h) a trace contaminant removal unit between a heat exchanger unit and an acid gas remover unit, to remove at least a substantial portion of one or more trace contaminants from the single cooled first gas stream, or, when present, one or more of the first, second, and third cooled first gas streams, wherein the single cooled first gas stream or the one or more of the first, second, and third cooled first gas streams further comprise one or more trace contaminants comprising one or more of COS, Hg and HCN;
(i) a reformer unit to convert a portion of the single methane product stream, or when present, at least a portion of one or more of the first, second, and third methane product streams into a syngas;
(j) a methane compressor unit to compress at least a portion of the single methane product stream, or when present, one or more of the first, second, and third methane product streams;
(k) a carbon dioxide recovery unit to separate and recover carbon dioxide removed by the single acid gas remover unit, or when present, one or more of the first, second, and third acid gas remover units;
(l) a sulfur recovery unit to extract and recover sulfur from the hydrogen sulfide removed by the single acid gas remover unit, or when present, one or more of the first, second, and third acid gas remover units;
(m) a catalyst recovery unit to extract and recover at least a portion of the entrained catalyst from at least a portion of the solid char product, and recycle at least a portion of the recovered catalyst to the single catalyst loading unit, or when present, one or more of the first, second, and third catalyst loading units;
(n) a gas recycle loop to recycle at least a portion of the single methane-depleted gas stream, or when present, at least a portion of one or more of the first methane-depleted gas stream, the second methane-depleted gas stream, and the third methane-depleted gas stream to at least one or more of the first, second, and third gasifying reactor units;
(o) a waste water treatment unit to treat waste water generated by the system;
(p) a superheater to superheat the steam in or from the single steam source, or when present the first steam source and/or second steam source;
(q) a steam turbine to generate electricity from at least a portion of the steam supplied by the single steam source, or when present the first steam source and/or the second steam source; and
(r) a sour shift unit between a heat exchanger and an acid gas remover unit, to contact a cooled first gas stream with an aqueous medium under conditions suitable to convert at least a portion of carbon monoxide in the cooled first gas stream to carbon dioxide.

3. The system according to claim 1, wherein the system comprises: (a) the first, second and third gasifying reactor units; (b) the first, second and third catalyst loading units; (c) the single carbonaceous material processing unit; (d) the first, second and third heat exchanger units; (e) the single acid gas remover unit; (f) the single methane removal unit; and (g) the single steam source.

4. The system according to claim 3, wherein the system further comprises one or more of:
(h) (1) a single trace contaminant removal unit between the first, second and third heat exchanger units and the single acid gas remover unit, to remove at least a substantial portion of one or more trace contaminants from the first, second and third cooled first gas streams; or
(2) a first and a second trace contaminant removal unit between the first, second and third heat exchanger units and the single acid gas remover unit to remove at least a substantial portion of one or more trace contaminants from the first, second and third cooled first gas streams; or
(3) a first, a second and a third trace contaminant removal unit between the first, second and third heat exchanger units and the single acid gas remover unit, to remove at least a substantial portion of one or more trace contaminants from the first, second and third cooled first gas streams;
(i) a single reformer unit to convert a portion of the single methane product stream into a syngas;
(j) a single methane compressor unit to compress at least a portion of the single methane product stream;
(k) a single carbon dioxide recovery unit to separate and recover carbon dioxide removed by the single acid gas remover unit;
(l) a single sulfur recovery unit to extract and recover sulfur from hydrogen sulfide removed by the single acid gas remover unit;
(m) (1) a single catalyst recovery unit to extract and recover at least a portion of the entrained catalyst from at least a portion of the solid char product from the first, second and third gasifying units, and recycle at least a portion of the recovered catalyst to one or more of the first, second and third catalyst loading units; or
(2) a first and a second catalyst recovery unit to extract and recover at least a portion of the entrained catalyst from at least a portion of the solid char product from the first, second and third gasifying units, and recycle at least a portion of the recovered catalyst to one or more of the first, second and third catalyst loading units; or
(3) a first, a second and a third catalyst recovery unit to extract and recover at least a portion of the entrained catalyst from at least a portion of the solid char product from the first, second and third gasifying reactor units, and recycle at least a portion of the recovered catalyst to one or more of the first, second and third catalyst loading units;
(n) a gas recycle loop to recycle at least a portion of the single methane-depleted gas stream to the first, second and third gasifying reactor units;
(o) a waste water treatment unit to treat waste water generated by the system;
(p) a superheater to superheat steam in or from the single steam source;
(q) a steam turbine to generate electricity from a portion of the steam supplied by the single steam source; and
(r) (1) a single sour shift unit between the first, second and third heat exchanger units and the single acid gas remover unit, to convert at least a portion of carbon monoxide in the first, second and third cooled first gas streams to carbon dioxide; or
(2) a first and a second sour shift unit between the first, second and third heat exchanger units and the single acid gas remover unit, to convert at least a portion of carbon monoxide in the first, second and third cooled first gas streams to carbon dioxide; or
(3) a first, a second and a third sour shift unit between the first, second and third heat exchanger units and the single acid gas remover unit, to convert at least a substantial portion of carbon monoxide in the first, second and third cooled first gas streams to carbon dioxide.

5. The system according to claim 1, wherein the system comprises: (a) the first, second and third gasifying reactor units; (b) the first, second and third catalyst loading units; (c) the single carbonaceous material processing unit; (d) the first, second and third heat exchanger units; (e) the first and second acid gas remover units; (f) the first and second methane removal units; and (g) the single steam source.

6. The system according to claim 5, wherein the system further comprises one or more of:
(h) (1) a first and a second trace contaminant removal unit between the first, second and third heat exchanger units and the first and second acid gas remover units to remove a substantial portion of one or more trace contaminants from the first, second and third cooled first gas streams; or
(2) a first, a second and a third trace contaminant removal unit between the first, second and third heat exchanger units and the first and second acid gas remover units, to remove a substantial portion of one or more trace contaminants from the first, second and third cooled first gas streams;
(i) (1) a single reformer unit to convert a portion of one or both of the first and second methane product stream into a syngas, or
(2) a first and a second reformer unit to convert a portion of the first and second methane product streams into a syngas;
(j) (1) a single methane compressor unit to compress at least a portion of one or both of the first and second methane product streams, or
(2) a first and a second methane compressor unit to compress at least a portion of the first and second methane product streams;
(k) (1) a single carbon dioxide recovery unit to separate and recover carbon dioxide removed by the first and second acid gas remover units, or
(2) a first and a second carbon dioxide recovery unit to separate and recover carbon dioxide removed by the first and second acid gas remover units;
(l) (1) a single sulfur recovery unit to extract and recover sulfur from hydrogen sulfide removed by the first and second acid gas remover units, or
(2) a first and a second sulfur recovery unit to extract and recover sulfur from hydrogen sulfide removed by the first and second acid gas remover units;
(m) (1) a single catalyst recovery unit to extract and recover at least a portion of the entrained catalyst from at least a portion of the solid char product from the first, second and third gasifying units, and recycle at least a portion of the recovered catalyst to one or more of the first, second and third catalyst loading units; or
(2) a first and a second catalyst recovery unit to extract and recover at least a portion of the entrained catalyst from the at least a portion of the solid char product from the first, second and third gasifying units, and recycle at least a portion of the recovered catalyst to one or more of the first, second and third catalyst loading units; or
(3) a first, a second and a third catalyst recovery unit to extract and recover at least a portion of the entrained catalyst from the solid char product from the first, second and third gasifying reactor units, and recycle at least a portion of the recovered catalyst to one or more of the first, second and third catalyst loading units;
(n) a gas recycle loop to recycle at least a portion of the first and second methane-depleted gas streams to the first, second and third gasifying reactor units;
(o) a waste water treatment unit to treat waste water generated by the system;
(p) a superheater to superheat steam in or from the single steam source;
(q) a steam turbine to generate electricity from a portion of the steam supplied by the single steam source; and
(r) (1) a first and a second sour shift unit between the first, second and third heat exchanger units and the first and second acid gas remover units, to convert at least a substantial portion of carbon monoxide in the first, second and third cooled first gas streams to carbon dioxide; or
(2) a first, a second and a third sour shift unit between the first, second and third heat exchanger units and the first and second acid gas remover units, to convert at least a substantial portion of carbon monoxide in the first, second and third cooled first gas streams to carbon dioxide.

7. The system according to claim 1, wherein the system comprises: (a) the first, second and third gasifying reactor units; (b) the single catalyst loading unit; (c) the single carbonaceous material processing unit; (d) the first, second and third heat exchanger units; (e) the single acid gas remover unit; (f) the single methane removal unit; and (g) the single steam source.

8. The system according to claim 7, wherein the system further comprises one or more of:
(h) (1) a single trace contaminant removal unit between the first, second and third heat exchanger units and the single acid gas remover unit, to remove at least a substantial portion of one or more trace contaminants from the first, second and third cooled first gas streams; or
(2) a first and a second trace contaminant removal unit between the first, second and third heat exchanger units and the single acid gas remover unit, to remove at least a substantial portion of one or more trace contaminants from the first, second and third cooled first gas streams; or
(3) a first, a second and a third trace contaminant removal unit between the first, second and third heat exchanger units and the single acid gas remover unit, to remove at least a substantial portion of one or more trace contaminants from the first, second and third cooled first gas streams;
(i) a single reformer unit to convert a portion of the single methane product stream into a syngas;
(j) a single methane compressor unit to compress at least a portion of the single methane product stream;
(k) a single carbon dioxide recovery unit to separate and recover carbon dioxide removed by the single acid gas remover unit;
(1) a single sulfur recovery unit to extract and recover sulfur from hydrogen sulfide removed by the single acid gas remover unit;
(m) (1) a single catalyst recovery unit to extract and recover at least a portion of the entrained catalyst from at least a portion of the solid char product from the first, second and third gasifying reactor units, and recycle at least a portion of the recovered catalyst to the single catalyst loading unit; or
(2) a first and a second catalyst recovery unit to extract and recover at least a portion of the entrained catalyst from at least a portion of the solid char product from the first, second and third gasifying reactor units, and recycle at least a portion of the recovered catalyst to the single catalyst loading unit; or
(3) a first, second and third catalyst recovery unit to extract and recover at least a portion of the entrained catalyst from at least a portion of the solid char product from the first, second and third gasifying reactor units, and recycle at least a portion of the recovered catalyst to the single catalyst loading unit;
(n) a gas recycle loop to recycle at least a portion of the single methane-depleted gas stream to the first, second and third gasifying reactor units;
(o) a waste water treatment unit to treat waste water generated by the system;
(p) a superheater to superheat steam in or from the single steam source;
(q) a steam turbine to generate electricity from a portion of the steam supplied by the single steam source; and
(r) (1) a single sour shift unit between the first, second and third heat exchanger units and the single acid gas remover unit, to convert at least a portion of carbon monoxide in the first, second and third cooled first gas streams to carbon dioxide; or
(2) a first and a second sour shift unit between the first, second and third heat exchanger units and the single acid gas remover unit, to convert at least a portion of carbon monoxide in the first, second and third cooled first gas streams to carbon dioxide; or
(3) a first, a second and a third sour shift unit between the first, second and third heat exchanger units and the single acid gas remover unit, to convert at least a portion of carbon monoxide in the first, second and third cooled first gas streams to carbon dioxide.

9. The system according to claim 1, wherein the system comprises: (a) the first, second and third gasifying reactor units; (b) the first, second and third catalyst loading units; (c) the single carbonaceous material processing unit; (d) the first, second and third heat exchanger units; (e) the first and second acid gas remover units; (f) the single methane removal unit, or the first and second methane removal units; and (g) the single steam source.

10. The system according to claim 9, wherein the system further comprises one or more of:
(h) (1) a first and a second trace contaminant removal unit between the first, second and third heat exchanger units and the first and second acid gas remover units, to remove at least a substantial portion of one or more trace contaminants from the first, second and third cooled first gas streams; or
(2) a first, a second and a third trace contaminant removal unit between the first, second and third heat exchanger units and the first and second acid gas remover units, to remove at least a substantial portion of one or more trace contaminants from the first, second and third cooled first gas streams;
(i) (1) if only the single methane removal unit is present, a single reformer unit to convert a portion of the single methane product stream into a syngas, or
(2) if the first and second methane removal units are present, (i) a single reformer unit to convert a portion of one or both of the first and second methane product streams into a syngas, or (ii) a first and a second reformer unit to convert a portion of the first and second methane product streams into a syngas;
(j) (1) if only the single methane removal unit is present, a single methane compressor unit to compress at least a portion of the single methane product stream, or
(2) if the first and second methane removal units are present, (i) a single methane compressor unit compress at least a portion of the first and second methane product streams, or (ii) a first and a second methane compressor unit to compress at least a portion of the first and second methane product streams;
(k) (1) a single carbon dioxide recovery unit to separate and recover carbon dioxide removed by the first and second acid gas remover units, or
(2) a first and a second carbon dioxide recovery unit to separate and recover carbon dioxide removed by the first and second acid gas remover units;
(l) (1) a single sulfur recovery unit to extract and recover sulfur from hydrogen sulfide removed by the first and second acid gas remover units, or
(2) a first and a second sulfur recovery unit to extract and recover sulfur from hydrogen sulfide removed by the first and second acid gas remover units;
(m) (1) a single catalyst recovery unit to extract and recover at least a portion of the entrained catalyst from at least a portion of the solid char product from one or more of the first, second and third gasifying reactor units, and recycle at least a portion of the recovered catalyst to one or more of the first, second and third catalyst loading units, or
(2) a first and a second catalyst recovery unit to extract and recover at least a portion of the entrained catalyst from at least a portion of the solid char product from two or more of the first, second and third gasifying reactor units, and recycle at least a portion of the recovered catalyst to one or more of the first, second and third catalyst loading units, or
(3) a first, a second and a third catalyst recovery unit to extract and recover at least a portion of the entrained catalyst from at least a portion of the solid char product from the first, second and third gasifying reactor unit, and recycle at least a portion of the recovered catalyst to one or more of the first, second and third catalyst loading units;
(n) a gas recycle loop to recycle at least a portion of the single methane-depleted gas stream, or the first and second methane-depleted gas streams, to the first, second and third gasifying reactor units;
(o) a waste water treatment unit to treat waste water generated by the system;
(p) a superheater to superheat steam in or from the single steam source;
(q) a steam turbine to generate electricity from a portion of the steam supplied by the single steam source; and
(r) (1) a first and a second single sour shift unit between the first, second and third heat exchanger units and the first and second acid gas remover units, to convert at least a portion of carbon monoxide in the first, second and third cooled first gas streams to carbon dioxide, or
(2) a first, a second and a third sour shift unit between the first, second and third heat exchanger units and the first and second acid gas remover units, to convert at least a substantial portion of carbon monoxide in the first, second and third cooled first gas streams to carbon dioxide.

11. The system according to claim 1, wherein the system comprises: (a) the first, second and third gasifying reactor units; (b) the single catalyst loading unit; (c) the single carbonaceous material processing unit; (d) the first, second and third heat exchanger units; (e) the first, second and third acid gas remover units; (f) the single methane removal unit, or the first and second methane removal units; and (g) the single steam source.

12. The system according to claim 11, wherein the system further comprises one or more of:
(h) a first, a second and a third trace contaminant removal unit between the first, second and third heat exchanger units and the first, second and third acid gas remover units, to remove at least a substantial portion of one or more trace contaminants from the first, second and third cooled first gas stream;
(i) (1) if only the single methane removal unit is present, a single reformer unit to convert a portion of the single methane product stream into a syngas, or
(2) if the first and second methane removal units are present, (i) a single reformer unit to convert a portion of one or both of the first and second methane product streams into a syngas, or (ii) a first and a second reformer unit to convert a portion of the first and second methane product streams into a syngas;
(j) (1) if only the single methane removal unit is present, a single methane compressor unit to compress at least a portion of the single methane product stream, or
(2) if the first and second methane removal units are present, (i) a single methane compressor unit to compress at least a portion of one or both of the first and second methane product streams, or (ii) a first and a second methane compressor unit to compress at least a portion of the first and second methane product streams;
(k) (1) a single carbon dioxide recovery unit to separate and recover carbon dioxide removed by the first, second and third acid gas remover units, or
(2) a first and a second carbon dioxide recovery unit to separate and recover carbon dioxide removed by the first, second and third acid gas remover units, or
(3) a first, a second and a third carbon dioxide recovery unit to separate and recover carbon dioxide removed by the first, second and third acid gas remover units;
(l) (1) a single sulfur recovery unit to extract and recover sulfur from hydrogen sulfide removed by the first, second and third acid gas remover units, or
(2) a first and a second sulfur recovery unit to extract and recover sulfur from hydrogen sulfide removed by the first, second and third acid gas remover units, or
(3) a first, a second and a third sulfur recovery unit to extract and recover sulfur from hydrogen sulfide removed by the first, second and third acid gas remover units;
(m) (1) a single catalyst recovery unit to extract and recover at least a portion of the entrained catalyst from at least a portion of the solid char product from one or more of the first, second and third gasifying reactor units, and recycle at least a portion of the recovered catalyst to the single catalyst loading unit, or
(2) a first and a second catalyst recovery unit to extract and recover at least a portion of the entrained catalyst from at least a portion of the solid char product from two or more of the first, second and third gasifying reactor units, and recycle at least a portion of the recovered catalyst to the single catalyst loading unit, or
(3) a first, a second and a third catalyst recovery unit to extract and recover at least a portion of the entrained catalyst from at least a portion of the solid char product from the first, second and third gasifying reactor units, and recycle at least a portion of the recovered catalyst to the single catalyst loading unit;
(n) a gas recycle loop to recycle at least a portion of the single methane-depleted gas stream, or the first and second methane-depleted gas streams, to the first, second and third gasifying reactor units;
(o) a waste water treatment unit to treat waste water generated by the system;
(p) a superheater to superheat steam in or from the single steam source;
(q) a steam turbine to generate electricity from a portion of the steam supplied by the single steam source; and
(r) a first, a second and a third sour shift unit between the first, second and third heat exchanger units and the first, second and third acid gas remover units, to convert at least a portion of carbon monoxide in the first, second and third cooled first gas streams to carbon dioxide.

13. The system according to claim 2, comprising at least (k), (l) and (m).

14. The system according to claim 8, comprising at least (k), (l) and (m).

15. The system according to claim 2, wherein the system comprises (k), and the system further comprises a carbon dioxide compressor unit to compress recovered carbon dioxide.

16. The system according to claim 8, wherein the system comprises (k), and the system further comprises a carbon dioxide compressor unit to compress recovered carbon dioxide.

17. The system according to claim 2, wherein the system comprises (r) and a trim methanator between an acid gas remover unit and a methane removal unit.

18. The system according to claim 8, wherein the system comprises (r) and a trim methanator between an acid gas remover unit and a methane removal unit.

19. The system according to claim 1, wherein the system produces a product stream of pipeline-quality natural gas.
